(19) United States
(12) Patent Application Publication
(10) Pub. No.: US 2025/0349178 A1
(43) Pub. Date: Nov. 13, 2025

(54) SYNCHRONIZING CONTROLS AND RESTRICTIONS BETWEEN A GAMING ESTABLISHMENT ACCOUNT AND A LINKED FINANCIAL INSTITUTION ACCOUNT

(71) Applicant: IGT, Las Vegas, NV (US)

(72) Inventors: Kevin Higgins, Reno, NV (US); Jeffery Shepherd, Reno, NV (US)

(21) Appl. No.: 18/657,249

(22) Filed: May 7, 2024

(51) Int. Cl. G07F 17/32; G06Q 20/10; G06Q 20/20

(52) U.S. Cl. CPC G07F 17/3241; G06Q 20/108; G06Q 20/204; G07F 17/3239; G07F 17/3244

(57) ABSTRACT

Systems and methods that, responsive to a restriction placement event occurring in association with a gaming establishment account, place a restriction on the gaming establishment account, and communicate data associated with the placed restriction which results in a component of a financial institution that maintains a created financial institution account linked to the gaming establishment account determining whether to place the restriction on the created financial institution account.

### BACKGROUND

In various embodiments, the systems and methods of the present disclosure link a gaming establishment account with a financial institution account created on behalf of a user and synchronize restrictions between the gaming establishment account and the created financial institution account.

Casinos are associated with multiple different channels of commerce including gaming activities (e.g., wagers on plays of games at electronic gaming machines and gaming tables) and non-gaming activities (e.g., making retail purchases at point-of-sale terminals throughout the casino).

### BRIEF DESCRIPTION OF THE SEVERAL VIEWS OF THE DRAWINGS

FIG. 1 is an example configuration of the architecture of a plurality of different components of the system of the present disclosure.

FIGS. 2A, 2B, 2C and 2D are example configurations of the synchronization of data between multiple entities.

FIG. 3 is a flow chart of an example process for operating a system which enables a restriction to be synchronized from a gaming establishment account to a bank account.

FIG. 4 is a flow chart of an example process for operating a system which enables a cleared restriction to be synchronized from a gaming establishment account to a bank account.

FIG. 5 is a flow chart of an example process for operating a system which enables an applicable restriction to factor into the processing of a purchase at a retail establishment made using a debit card associated with a bank account linked to a gaming establishment account.

### DETAILED DESCRIPTION

In various embodiments, the systems and methods of the present disclosure place a restriction on a gaming establishment account responsive to a restriction placement event occurring in association with the gaming establishment account. The systems and methods of these embodiments communicate data associated with the placed restriction. Such a communication results in a component of a financial institution that maintains a created financial institution account linked to the gaming establishment account placing, in certain instances, the restriction on the created financial institution account.

In certain embodiments, following the creation or otherwise integration of a dedicated financial institution account maintained a financial institution with one or more gaming establishment accounts maintained by a gaming establishment fund management system, the system of the present disclosure synchronizes zero, one or more restrictions based on the financial institution account and/or such gaming establishment accounts. In these embodiments, while the system of the present disclosure offers fund transfers between a gaming establishment fund management account maintained for a user (e.g., a user's cashless wagering account) and a dedicated financial institution account created for that user (e.g., a gaming checking account), one or more components of the system monitor for any account state change events associated with the dedicated financial institution account and/or the gaming establishment account and cause a modification of zero, one or more attributes of one or more of such accounts responsive to certain events occurring. As such, the system synchronizes different account information and/or states between one or more gaming establishment accounts and a financial institution account to reduce the likelihood of fraud when suspecious activity occurs in association with any of the gaming establishment accounts and/or the financial institution account.

In operation of certain embodiments, one or more components of one or more systems, such as a server of a financial institution that maintains a financial institution account (e.g., a server of a banking institution that maintains a bank account) and/or a server of a gaming establishment fund management system, monitor for an occurrence of certain designated activity, such as activities that qualify as an occurrence of a material event relative to a gaming establishment account and/or a financial institution account employed to access funds associated with that gaming establishment account. In certain such embodiments, if activities representative of malicious activity are detected, such components designate this activity as occurring in association with one or more gaming establishment accounts and/or a financial institution account employed to access funds in one or more gaming establishment accounts. In certain embodiments, such a designation includes modifying the state of the gaming establishment account and/or the financial institution account, such as placing a block, a lock and/or a closure on such a gaming establishment account and/or the financial institution account. Accordingly, in certain embodiments, the present disclosure provides the synchronization of account restrictions (e.g., account blocks, locks and/or closures) between a financial institution account associated with a user's gaming establishment fund management account and the user's gaming establishment fund management account, such as the user's cashless wagering account.

In addition to monitoring for any suspecious activity and designating one or more gaming establishment accounts and/or a financial institution account as associated with such activity that occurs, in certain instances, one or more components of one or more systems of the present disclosure disseminate information associated with one or more accounts, the monitored activity and/or the designation to one or more other components of one or more other systems. In certain embodiments, the system determines whether or not to disseminate such information and if so, one or more destinations of such information. In these embodiments, since certain actions taken against a gaming establishment account are relatively most relevant to only that gaming establishment account while certain other actions taken against a gaming establishment account and/or a financial institution account associated with a gaming establishment account are relevant to multiple gaming establishment accounts and/or the financial institution account, the system determines whether or not the action taken warrants being shared.

In certain embodiments, upon an occurrence of certain account information modifications, certain detected activity and/or the placement of a restriction on a gaming establishment account and/or a financial institution account (e.g., a placement of a block and/or a lock on the account) and a determination to share data associated with such events to other systems, one or more components of one or more systems cause a synchronization to occur which results in other gaming establishment accounts and/or the financial institution account also being associated with the account information modification, the detected activity and/or the placement of the restriction. In certain embodiments, the component which detects the account information modification, the activity and/or places the restriction propagates the detected account information modification, the detected activity and/or the placement of the restriction to one or more other components of other systems. In certain other embodiments, the component which detects the account information modification, detects the activity and/or places the restriction reports the detected account information modification, the detected activity and/or the placement of the restriction to a component of an event system which operates to make such detected account information modification, such detected activity and/or the placement of the restriction available to other components of other systems. In certain other embodiments, a component of the event system monitors one or more components of one or more systems for any account information modifications, any designated activity and/or the placement of any restriction and makes such detected account information modifications, detected activity and/or the placement of the restriction available to other components of other systems. In these embodiments, the periodic synchronization of the different account information data, the different restriction states (e.g., a locked and/or blocked state versus an unlocked state) and/or the different restriction limits (e.g., limits on a total amount of transactions employing a financial institution account in a designated period of time) of the different gaming establishment accounts and/or the financial institution account ensure that such accounts (individually and/or collectively) remain within the confines of the various jurisdictional requirements as well as banking and anti-money laundering regulations. Accordingly, the system monitors the activities associated with one or more gaming establishment accounts and/or a financial institution account associated with one or more such accounts and synchronizes information associated with such monitored activities across the various disparate, but interconnected components of the system (which may extend across different sites, different gaming vertical boundaries and/or different non-gaming vertical boundaries) to improve user security and reduces the likelihood of fraud when malicious activity occurs or is otherwise being attempted.

In addition to the created (or otherwise integrated) financial institution account operating as a gateway to potentially access, in real time, funds that previously were maintained in a gaming establishment account and subject to various delays in the movement of such funds to and from the gaming establishment account, in certain embodiments, one or more components of the system operate with one or more components of a banking institution to harmonize one or more security measures between the gaming establishment account and the financial institution account associated with the gaming establishment account. In these embodiments, since employing different security measures, such as different personal identification numbers, between the gaming establishment account and the financial institution account associated with the gaming establishment account have the benefit of reducing instances of fraud but the downside of requiring the user to remember each individual security measure, such as each individual personal identification number (“PIN”), associated with each of the gaming establishment account(s) and the financial institution account (and/or a payment instrument associated with the financial institution account) creates friction in the user's experience, the system of the present disclosure maintains the employment of the different individual security measures while reducing the need for the user to remember each of the individual security measures. As such, the system of certain embodiments synchronizes different security measures employed for each of one or more gaming establishment accounts and a financial institution account to reduce the computational load placed on certain components associated with the financial transaction and further reduce friction encountered by the user while maintaining the reduced likelihood of fraud realized when multiple security measures are employed.

In various embodiments, the present disclosure is directed to a system, such as a gaming establishment fund management system, including various sub-systems that are each associated with or otherwise maintain one or more electronic or virtual accounts. In these embodiments, the various accounts maintained for a user individually or collectively form a resort or enterprise account (i.e., a gaming establishment fund management account) for the user. That is, the collection of cashless wagering accounts (e.g., cashless gaming establishment wagering wallets, cashless sports wagering wallets and/or cashless mobile wagering wallets) and gaming establishment retail accounts (e.g., gaming establishment retail wallets) associated with or otherwise maintained for a user, such as a retail patron, individually or collectively form a resort or enterprise account (i.e., an integrated resort or gaming establishment fund management wallet) that the user may access to transfer funds and/or view balance information amongst the various accounts associated with or otherwise maintained for the user.

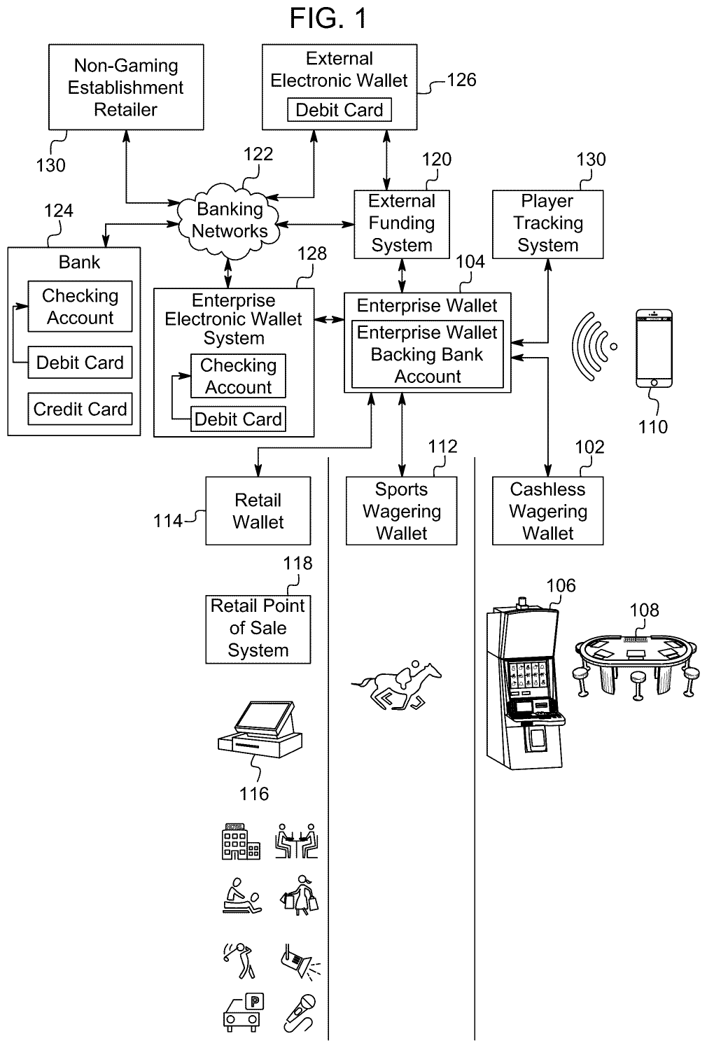

In various embodiments, the gaming establishment fund management system includes or is otherwise associated with one or more cashless wagering systems. Each cashless wagering system is associated with or otherwise maintain one or more cashless wagering accounts. In certain embodiments, the gaming establishment fund management system includes a first cashless wagering system that maintains a first cashless wagering account. In these embodiments, a user, such as a player of an electronic gaming machine (“EGM”), utilizes a mobile device application running on a mobile device and/or a physical instrument (e.g., a smart card or a user issued magnetic striped card which the user utilizes via inserting the card into a card reader associated with the EGM) to facilitate the electronic transfer of any funds between this first cashless wagering account and a gaming device, such as a component of a gaming table and/or an EGM (including, but not limited to, a slot machine, a video poker machine, a video lottery terminal, a terminal associated with an electronic table game, a terminal associated with a live table game, a video keno machine, a video bingo, and/or a sports betting terminal (that offers wagering games and/or sports betting opportunities)). For example, as seen in FIG. 1, the gaming establishment fund management system includes a first cashless wagering system (not shown) that maintains a Cashless Wagering Wallet 102 (e.g., a first cashless wagering account) which is in communication with the enterprise wallet 104. In this example, to facilitate the transfer of funds between this cashless wagering account and a credit balance of an EGM 106 and/or a credit balance of a gaming table component (not shown) associated with a gaming table 108, the system utilizes a mobile device 110 running a mobile device application that interfaces with one or more components of the gaming establishment fund management system to enable a user, such as a player of the EGM or a player at the gaming table, access to this first cashless wagering account.

In certain embodiments, the gaming establishment fund management system additionally or alternatively includes or is otherwise associated with a second cashless wagering system that maintains a second cashless wagering account. In these embodiments, funds associated with the second cashless wagering account are utilized to place one or more sporting event wagers and/or wagers placed remote from an EGM and a gaming table. In such embodiments, a user utilizes a mobile device application running on a mobile device and/or a physical instrument (e.g., a smart card or a user issued magnetic striped card which the user utilizes via inserting the card into a kiosk) to facilitate the electronic transfer of any funds between this second cashless wagering account and a credit balance accessible to wager on sporting events and/or games of chance (or games of skill) remote from an EGM and a gaming table. For example, as seen in FIG. 1, the gaming establishment fund management system includes a second cashless wagering system (not shown) that maintains a Sports Wagering Wallet 112 (e.g., a second cashless wagering account) which is in communication with the enterprise wallet 104. In this example, to facilitate the transfer of funds between this cashless wagering account and a credit balance associated with a sporting event wagering system (not shown) and/or a remote wagering system (not shown) to enable the placement of one or more wagers on one or more sporting events and/or one or more games of chance (or games of skill), the system utilizes a mobile device 110 running a mobile device application that interfaces with one or more components of the gaming establishment fund management system to enable, amongst other activities, a user, such as a user remote from the gaming establishment, access to this second cashless wagering account.

In various embodiments, in addition to or an alternative of maintaining one or more cashless wagering accounts via one or more cashless wagering systems, the gaming establishment fund management system includes or is otherwise associated with one or more gaming establishment retail wallet systems that each maintain one or more gaming establishment retail accounts. In certain embodiments, such a gaming establishment retail account (e.g., a gaming establishment retail wallet) of a gaming establishment retail wallet system integrates with various retail point-of-sale systems throughout the gaming establishment (or located remote from the gaming establishment, but otherwise associated with the gaming establishment) to enable users to purchase goods and/or services via the user's gaming establishment retail account. For example, as seen in FIG. 1, the gaming establishment fund management system includes a gaming establishment retail wallet system (not shown) that maintains a Retail Wallet 114 (e.g., a gaming establishment retail account) which is in communication with the enterprise wallet 104. In this example, to facilitate the transfer of funds between this gaming establishment retail account and an account associated with a gaming establishment retailer to purchase goods and/or services from the gaming establishment retailer, the system utilizes a retail wallet identity, such as a mobile device 110 running a mobile device application that interfaces with a point-of-sale terminal 116 of a retail point-of-sale system 118 of the gaming establishment retailer and/or a physical instrument (e.g., a smart card or a user issued magnetic striped card which the user utilizes in association with the point-of-sale terminal), and one or more components of the gaming establishment fund management system to enable a user access to this gaming establishment retail account. In other embodiments, the gaming establishment fund management system does not maintain a separate gaming establishment retail account, but rather utilizes the gaming establishment retail wallet system as a transaction coordinator to account for any transactions to purchase goods and/or services from a gaming establishment retailer.

In certain embodiments, a gaming establishment retail account is a retail account associated with a user having a balance or a pre-paid access account which, per current regulations from the U.S. Treasury Department Financial Crimes Enforcement Network (“FinCEN”), cannot be convertible to cash and can only be used for the purchase of goods and/or services. In these embodiments, such a gaming establishment retail account integrates with various retail point-of-sale systems of various retail establishments throughout or otherwise associated with a gaming establishment to enable users to purchase goods and/or services via the user's gaming establishment retail account. Accordingly, in certain embodiments, based on one or more jurisdictional regulations, an amount of funds deposited in a gaming establishment retail account may be used with various retail point-of-sale systems throughout the gaming establishment (or remote from, but otherwise associated with the gaming establishment) to enable users to purchase goods and/or services, but such funds deposited in the gaming establishment retail account cannot be converted to cash or check. In certain other embodiments, based on one or more different jurisdictional regulations, an amount of funds deposited in a gaming establishment retail account, such as an account associated with an identified user, may be used with various retail point-of-sale systems throughout the gaming establishment (or remote from, but otherwise associated with the gaming establishment) to enable users to purchase goods and/or services wherein such funds deposited in the gaming establishment retail account may be converted to or otherwise redeemable for cash or check.

In various embodiments, one or more of the accounts of the gaming establishment fund management system are associated with one or more backing bank accounts. In these embodiments, since certain regulations require that at least the funds held in association with one or more of the accounts of the gaming establishment fund management system be held in a financial institution account associated with the gaming establishment fund management system, the system of the present disclosure employs one or more of such backing bank accounts (to ensure compliance with applicable regulations) and further operates with one or more financial institutions to periodically reconcile the funds in such a backing bank account to reflect fund transfers associated with one or more accounts maintained by the gaming establishment fund management system. For example, as seen in FIG. 1, the enterprise wallet 104 maintained by the gaming establishment fund management system is associated with an enterprise wallet backing bank account that the gaming establishment fund management system operates with a component of a financial institution that maintains such a backing bank account to automatically move (or move responsive to commands from appropriate personnel) funds into and out of based on transactions made against the accounts maintained by the gaming establishment fund management system. It should be appreciated that while the enterprise wallet of this illustrated example is associated with an enterprise wallet backing bank account, any other account maintained by the system of the present disclosure, such as the illustrated first cashless wagering account, the illustrated second cashless wagering account and/or the illustrated gaming establishment retail account, may additionally or alternatively be associated with a backing bank account.

In certain embodiments, the gaming establishment fund management system includes or is otherwise in communication with one or more external funding sources which maintain one or more external accounts for the user. For example, as seen in FIG. 1, the gaming establishment fund management system that maintains the enterprise wallet 104 is in communication with an external funding system 120 which is in communication with a network of one or more banks or other financial institutions (i.e., the banking network 122) which operate to electronically transfer funds between the user's accounts maintained at such banks or financial institutions (i.e., bank 124 maintaining an external checking account associated with a debit card and/or a credit card) and one or more of the accounts maintained by the gaming establishment fund management system. As further seen in FIG. 1, in this example, the external funding system 120 is in communication (directly or indirectly via banking network 122) with an external electronic wallet 126 associated with a debit card, such as a pre-paid debit card, which operates to electronically transfer funds between the user's external electronic wallet and one or more of the accounts maintained by the gaming establishment fund management system. In certain embodiments, funds maintained in the accounts of the external funding sources may be transferred to and/or from one or more accounts maintained by the gaming establishment fund management system. These accounts of the external funding sources include, but are not limited to, one or more external checking accounts maintained by one or more financial institutions (e.g., one or more banks and/or credit unions), one or more external savings accounts maintained by one or more financial institutions, one or more external financial institution accounts, such as a brokerage account, maintained by one or more financial institutions, one or more external credit card accounts maintained by one or more financial institutions, one or more external debit card accounts maintained by one or more financial institutions, and/or one or more external third-party maintained accounts (e.g., one or more PayPal® accounts or Venmo® accounts). It should be appreciated that while illustrated as the gaming establishment fund management system being in communication with one or more external funding sources, in different embodiments, any system or sub-system of the present disclosure can be in communication with one or more external funding sources. In different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to facilitate the transfer of funds to/from an external account.

In certain embodiments, the gaming establishment fund management system includes or is otherwise associated with an enterprise electronic wallet system. In these embodiments, the enterprise electronic wallet system operates to open, be associated with or otherwise owns one or more dedicated bank accounts on behalf of a user. In certain embodiments, the enterprise electronic wallet system opened bank account is associated with one or more debit cards for a user (which are independent of any debit cards associated with any external accounts maintained at any financial institution). Such a debit card operates to enable a user access to funds that may be transferred to a gaming device of a gaming establishment and/or used at one or more channels of commerce associated with the gaming establishment and/or independent of the gaming establishment. For example, as seen in FIG. 1, the gaming establishment fund management system that maintains the enterprise wallet 104 is in communication with an enterprise electronic wallet system 128 to facilitate the synchronization of data between these different systems as well as the access of an amount of funds held in a checking account opened by the enterprise electronic wallet system on behalf of a user and employing a debit card (and/or other payment instrument) provided to the user. In this example, as also seen in FIG. 1, the network of one or more banks or other financial institutions (i.e., the banking network 122) is in communication with the enterprise electronic wallet system 128 to facilitate at least the settlement of funds held in the created accounts accessed via a debit card provided to the user. It should be appreciated that while illustrated as the gaming establishment fund management system being in communication with one or more enterprise electronic wallet systems to facilitate the transfer of funds and/or the synchronization of data, in different embodiments, any system or sub-system of the present disclosure can be in communication with one or more enterprise electronic wallet systems to facilitate the transfer of funds and/or the synchronization of data. It should be further appreciated that in different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the enterprise electronic wallet system.

In certain embodiments, the enterprise electronic wallet system is associated with a single gaming establishment. In certain embodiments, the enterprise electronic wallet system is associated with a plurality of gaming establishments. In certain embodiments, the dedicated bank account is associated with a single gaming establishment. In these embodiments, a separate dedicated bank account is created on behalf of each eligible user of each individual gaming establishment. In certain embodiments, the dedicated bank account is associated with a group of gaming establishments. In these embodiments, a dedicated bank account is created on behalf of each eligible user of the group of a gaming establishments.

In certain embodiments, the dedicated bank account linked to a gaming establishment account associated with the user, such as a cashless wagering account, facilitates the movement of funds within a gaming establishment environment via a gaming device interfacing with a component of the gaming establishment fund management system that maintains the gaming establishment account. For example, upon a user's request to transfer to an EGM of a gaming establishment an amount of funds displayed as being held in a cashless wagering account maintained for that user (but actually held in a dedicated bank account dedicated to that user), one or more components of the system operate to transfer the funds, without any external bank account transfer delays, from the dedicated bank account to the EGM. In this example, such a transfer occurs via an indirect transfer from the dedicated bank account to the cashless wagering account maintained for the user and then to the EGM (or via a direct transfer, facilitated by a cashless wagering system that maintains the cashless wagering account, from the dedicated bank account to the EGM). In another example, upon a user cashing out an amount of funds from an EGM of a gaming establishment (i.e., an occurrence of a funding event), one or more components of the system operate to transfer the funds to a dedicated bank account such that the funds become available for use within the gaming establishment as well as outside of the gaming establishment. In this example, such a transfer occurs via an indirect transfer from the EGM to a cashless wagering account maintained for that user and then to the dedicated bank account (or via a direct transfer, facilitated by a cashless wagering system that maintains the cashless wagering account, from the EGM to the dedicated bank account). It should be appreciated that in addition to transferring, directly or indirectly, funds between a gaming establishment account and a dedicated bank account, since the gaming establishment account maintained for the user is associated with one or more backing bank accounts that hold at least a corresponding amount of funds as the funds attributed to the gaming establishment account, when funds move between the gaming establishment account and the dedicated bank account, the system creates one or more ledgers of the existence of a debt between the sender of the funds and the receiver of the funds. In these embodiments, upon an occurrence of a settlement event, such as after a designated period of time (e.g., at the end of a day), the system reconciles such outstanding debt by initiating the transfer of funds between the appropriate bank accounts.

In certain instances, the balance of one or more dedicated bank accounts created by the enterprise electronic wallet system on behalf of a user are drawn down via transactions initiated by the provided payment instrument (e.g., debit card) and accessible at a point-of-sale-terminal external from any gaming establishment channel of commerce (e.g., a non-gaming establishment retailer 130 in communication, via the banking network 122). In certain instances, the balance of one or more dedicated bank accounts created by the enterprise electronic wallet system on behalf of a user are additionally or alternatively drawn down via transactions accessible at a gaming device, such as an EGM 106 and/or a gaming table 108a. In certain instances, the balance of one or more dedicated bank accounts created by the enterprise electronic wallet system on behalf of a user are drawn down via transactions accessible at a point-of-sale terminal 116 within a gaming establishment channel of commerce.

It should be appreciated that unlike prior payment solutions in which if a user wants to access their funds held in a casino account at a retail establishment outside of the casino, the user needs to first transfer their funds to an external bank account (after which the user can then pay at that retail establishment outside of the casino using a debit card or credit card associated with their external bank account), or alternatively first transfer their funds to an external electronic wallet (after which the user can use a pre-paid debit card associated with their external electronic wallet to pay at that retail establishment outside of the casino), the creation of the dedicated bank account in association with the system of the present disclosure enables a user to avail themselves of the use of a payment instrument, such as a debit card, for purchases made outside of the casino while still having funds readily available for use within the casino.

Accordingly, in certain embodiments, the system of the present disclosure enables the balance of the user's gaming establishment account to be transferred, upon a funding event, to a dedicated bank account (that is dedicated to the user and remains owned by the system of the present disclosure) such that funds that previously were not immediately accessible outside of the casino become accessible via a payment instrument associated with the dedicated bank account. In these embodiments, by associating a gaming establishment account maintained for a user, a created bank account dedicated to the user and linked to the gaming establishment account and an electronic wallet (e.g., a financial transaction application that runs on a mobile device and securely stores payment information, such as debit card information, and passwords to enable the payment of goods and/or services), the system of the present disclosure operates to enable funds to flow between different verticals quicker than previously available. In other words, by integrating a bank account created in association with the system directly with one or more gaming establishment accounts, the present disclosure enables a payment instrument associated with the dedicated bank account to function as an interface to access funds independent of any involvement of any other external accounts that require a relatively extended period of time to transfer funds to. Such a configuration thus enables a user to access the network payment processors accessible with certain payment instruments, such as debit cards, without first needing to transfer any amounts of funds from a gaming establishment account to an external account associated with the debit card to gain such access. Such a configuration additionally saves users time (e.g., no time needs to be spent transferring funds from a gaming establishment account to an external banking account associated with a debit card or waiting a dedicated amount of time for such a transfer to be completed) and offers operational efficiencies (e.g., reducing the number of touchpoints funds must flow through before they may be used) compared to prior payment solutions involving funds in a casino account.

It should be further appreciated that unlike prior systems that required one or more inputs to transfer funds in a gaming establishment account to an external financial institution account associated with a debit card and further required a certain amount of time, such as up to three days, for the transfer to be completed and the transferred funds to become available for use using a debit card, the present disclosure bypasses these prolonged transfers (and in doing so further bypasses the need for the external financial institution account previously employed) and enables the system to interact, in real time, with various gaming establishment components and/or non-gaming establishment components such that the funds that otherwise would have to be maintained in a gaming establishment account (to enable such funds to be transferred to a gaming device) are available, via the employment of the dedicated bank account, for immediate use at a gaming device (via interfacing with a gaming establishment fund management system) or at a non-gaming device (via employing a payment instrument associated with such an account as a gateway to such funds). As such, the system of the present disclosure offers the benefits of bank account transactions without the fund transfer friction and timing restrictions previously encountered in moving funds from a gaming establishment account, thereby providing the user greater control over their funds.

Accordingly, in view of the different channels of commerce available both in association with and independent of one or more gaming establishments, the system offers a dedicated bank account created in association with the system that enables access to funds in different channels of commerce associated with or independent of one or more gaming establishments. Such transfers thus reduce the fund movement friction encountered in using funds otherwise held in a gaming establishment account to complete transactions outside of the gaming establishment network while still realizing the benefits of network payment processors offered by the use of payment instruments associated with the dedicated bank account. Such a configuration further facilitates, amongst other benefits, a more cashless environment (e.g., cash does not need to be withdrawn from a gaming establishment account and then brought to a retailer, either internal to or external from the gaming establishment, to purchase goods and/or services) which increases safety (e.g., minimizing users having to carry large sums of cash associated with large sums of money and minimizing such cash being a vehicle to spread potentially harmful contagions).

In certain embodiments, the system enables the user to fund the dedicated bank account associated with a gaming establishment account using one or more bank account transfers (e.g., an automated clearing house (“ACH”) transfer), a guaranteed ACH transfer, and/or an electronic check (“eCheck”) transfer). In certain embodiments, the system enables the user to fund the dedicated bank account associated with a gaming establishment account using one or more of a transfer based on credit card information, a transfer based on external debit card information, a transfer based on a third-party maintained account (e.g., one or more PayPal® accounts or Venmo® accounts). In certain embodiments, the system enables the user to fund the dedicated bank account associated with a gaming establishment account using a mobile device electronic fund transfer, such as using Apple Pay™ or Android Pay™. It should be appreciated that in different embodiments, the system utilizes a mobile device running a mobile device application, a kiosk, an EGM, a gaming table component, a service window displayed by a gaming device (e.g., a remote host controlled service window displayed by an EGM) and/or a gaming establishment interface to facilitate the transfer of funds from a third-party account to the dedicated bank account.

In certain embodiments, the system enables funds to be deposited in a dedicated bank account associated with a gaming establishment account via activating a line of credit associated with the user. In certain embodiments, the system enables funds to be deposited in a dedicated bank account associated with a gaming establishment account, via a gaming device, such as an EGM and/or via a non-gaming device, such as a kiosk. In certain embodiments, the system enables a user that has an amount of cash to utilize a gaming device and/or a non-gaming device to convert the cash to an amount deposited into a dedicated bank account associated with a gaming establishment account. In certain embodiments, the system enables funds to be deposited in a dedicated bank account associated with a gaming establishment account via a gaming establishment interface, such as a gaming establishment cage or desk. In certain embodiments, the system enables a user that has an amount of cash to utilize a gaming establishment interface, such as a gaming establishment cage or desk to convert the cash to an amount deposited into a dedicated bank account.

In certain embodiments, the system enables funds to be deposited in a dedicated bank account associated with a gaming establishment account via a gaming device and/or a non-gaming device that accepts printed ticket vouchers. In these embodiments, the system enables a user that has one or more printed ticket vouchers to utilize a gaming device and/or a non-gaming device to convert the printed ticket voucher to an amount deposited into the dedicated bank account. In other embodiments, the system enables funds to be deposited in a dedicated bank account associated with a gaming establishment account via a gaming establishment interface that accepts printed ticket vouchers. In these embodiments, the system enables a user that has one or more printed ticket vouchers to utilize a gaming establishment interface to convert the printed ticket voucher to an amount deposited into the dedicated bank account. In certain embodiments, the dedicated bank account is associated with funds associated with one or more virtual ticket vouchers. In certain embodiments, the system enables a user associated with an amount of virtual ticket vouchers to utilize a gaming device (e.g., an EGM, or a component of an EGM), a non-gaming device (e.g., a kiosk), a mobile device running a mobile device application, and/or a gaming establishment interface to convert the virtual ticket vouchers to an amount deposited into a dedicated bank account associated with a gaming establishment account.

In certain embodiments, in association with the employment of a dedicated bank account associated with a gaming establishment account, the system provides the user a payment instrument, such as a debit card, an Automated Teller Machine (“ATM”) card, and/or one or more negotiable instruments (e.g., one or more checks, money orders and/or promissory notes), to facilitate the use of funds residing in the dedicated bank account. In one such embodiment, the payment instrument, such as a debit card, takes the form of a physical instrument (e.g., a smart debit card that stores account information, a magnetic striped debit card that stores account information, a smart debit card that does not store any account information but is associated with a debit card number that is associated with account information in one or more maintained databases, a magnetic striped debit card that does not store any account information but is associated with a debit card number that is associated with account information in one or more maintained databases). In another such embodiment, the payment instrument, such as a debit card, additionally or alternatively takes the form of a virtual instrument (e.g., a mobile device application that stores account information, a mobile device application that does not store any account information but is associated with a debit card number that is associated with account information in one or more maintained databases, and/or a component of a mobile device operating system that stores account information and is operable with a point-of-sale terminal). In one such embodiment, information associated with the virtual debit card is communicated from the financial institution to a gaming establishment mobile device application running on the user's mobile device. In another such embodiment, information associated with the virtual debit card is communicated from the financial institution to the user's mobile device to be stored in a wallet application being run on the user's mobile device.

As such, to provide a user instant access outside of a gaming establishment to funds that would otherwise reside in a gaming establishment account for gaming purposes, the system of the present disclosure creates and integrates a bank account with a gaming establishment account maintained for that user. Such a configuration enables funds to be accessed both at gaming establishment verticals and non-gaming establishment verticals without the need to wait for any extended periods of time for fund transfers from a gaming establishment account to an external financial institution account to be completed (or alternatively pay various surcharge fees to expedite such fund transfers).

In certain embodiments, as mentioned above, the system enables a user to transfer funds from a dedicated bank account associated with a gaming establishment account to/from a gaming establishment device, such as an EGM, in association with one or more components of the gaming establishment fund management system, such as a component of a cashless wagering system. In these embodiments, the gaming establishment fund management system operates with the enterprise electronic wallet system (that created the dedicated bank account associated with a gaming establishment account) to facilitate the transfer of funds to one or more destinations. In certain embodiments, the user interfaces with one or more components associated with the gaming establishment fund management system to transfer an amount of funds to the gaming establishment device, such as an EGM, and the gaming establishment fund management system interfaces with the enterprise electronic wallet system to potentially complete the transfer of funds from the dedicated bank account associated with the gaming establishment account to the gaming establishment device. In these embodiments, responsive to the user indicating an amount of funds to transfer to the gaming establishment device, the gaming establishment fund management system initiates a requested transfer of funds from the dedicated bank account to the gaming establishment device. That is, responsive to a user requesting a transfer of funds to an\ gaming establishment device, one or more components of a gaming establishment fund management system operate with one or more components that maintains the dedicated bank account associated with the gaming establishment account to potentially complete the transfer. In these embodiments, subject to the transfer being approved (and the applicability of zero, one or more usage controls, restrictions and/or security measures as described below), the one or more components of the gaming establishment fund management system transfer (or otherwise approve a transfer for subsequent settlement upon an occurrence of a settlement event) an amount of funds to the gaming establishment device from the dedicated bank account created for the user.

In certain embodiments, the user interfaces with one or more components associated with the gaming establishment fund management system to transfer an amount of funds from a gaming establishment device, such as an EGM. In such embodiments, the gaming establishment fund management system interfaces with the enterprise electronic wallet system to potentially complete the transfer of funds to the dedicated bank account associated with a gaming establishment account to the gaming establishment device. In these embodiments, responsive to the user requesting, via a cashout request coupled with designating a fund destination, to transfer an amount of funds from the gaming establishment device, the gaming establishment fund management system initiates a requested transfer of funds from the gaming establishment device to the dedicated bank account associated with the gaming establishment account. In such embodiments, responsive to a user requesting a transfer of funds from a gaming establishment device (and the applicability of zero, one or more usage controls, restrictions and/or security measures as described below), one or more components of a gaming establishment fund management system operate with one or more components that maintains the dedicated bank account associated with the gaming establishment account to potentially complete the transfer. In these embodiments, subject to the transfer being approved, the one or more components of the gaming establishment fund management system transfer (or otherwise approve a transfer for subsequent settlement upon an occurrence of a settlement event) an amount of funds to the dedicated bank account created for the user from the gaming establishment device. In these embodiments, a cashout of funds from the gaming establishment device result in a transfer of funds to the dedicated bank account.

It should be appreciated that the electronic fund data transfers of the present disclosure may occur in addition to or as an alternative from cash-based fund transfers and/or ticket voucher-based fund transfers. In one such embodiment, an amount of funds transacted against is funded via any of an electronic fund transfer, a cash-based fund transfer or a ticket voucher-based fund transfer. In another embodiment, an amount of funds transacted against is funded via an electronic fund transfer or a cash-based fund transfer (but is not funded via any ticket voucher-based fund transfer). In another embodiment, an amount of funds transacted against is funded via an electronic fund transfer or a ticket voucher-based fund transfer (but is not funded via any cash-based fund transfer). In another embodiment, an amount of funds transacted against is funded via an electronic fund transfer (but is not funded via a cash-based fund transfer nor a ticket voucher-based fund transfer).

In certain embodiments, the gaming establishment fund management system is in communication with one or more gaming establishment patron management systems (e.g., player tracking system 132 of FIG. 1) that monitor activities at various points of contact associated with the gaming establishment and provides rewards, such as redeemable player tracking points, in association with such activities. It should be appreciated that while, in certain embodiments, the gaming establishment fund management system is in communication with one or more gaming establishment patron management systems, in different embodiments, any system or sub-system of the present disclosure can be in communication with one or more gaming establishment patron management systems. In different embodiments, the system utilizes a mobile device running a mobile device application, a kiosk, an interface of a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the gaming establishment patron management system.

In certain embodiments, the gaming establishment fund management system is integrated with an event system that is employed in the synchronization of account information, usage controls, and/or restrictions between different components that interface with the dedicated bank account and/or the linked gaming establishment account. In certain other embodiments, the gaming establishment fund management system is additionally or alternatively in communication with an external event system that is employed in the synchronization of account information, usage controls, and/or restrictions between different components that interface with the dedicated bank account and/or the linked gaming establishment account. For example, an event system monitors different events occurring in association with different accounts, reports different events occurring in association with different accounts, and/or applies (or cause an application of) zero, one or more restrictions based on different events occurring in association with different accounts.

In certain embodiments, the gaming establishment fund management system is in communication with one or more credit systems which each issue the user one or more lines of credit. These lines of credit are accessible to facilitate a transfer of funds from the line of credit issued by the credit system to (either directly or indirectly through a cashless wagering account) a credit balance of a gaming device, such as an EGM and/or a gaming table and/or to (either directly or indirectly through a gaming establishment retail account) a point-of-sale terminal (or an account associated with the point-of-sale terminal). It should be appreciated that the gaming establishment fund management system may be in communication with one or more credit systems, and in different embodiments, any system or sub-system of the present disclosure can be in communication with one or more credit systems. It should be further appreciated that in different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the gaming establishment credit system.

In certain embodiments, the gaming establishment fund management system is also in communication with one or more credit reporting/credit risk systems which monitor and report on various accounts associated with the user. For example, the gaming establishment fund management system that maintains the enterprise wallet is in communication with one or more credit reporting and risk systems. These credit reporting and risk systems monitor and report on a credit rating and status of one or more accounts maintained for the user at various funding sources, such as various financial institutions. It should be appreciated that while, in certain embodiments, the gaming establishment fund management system being in communication with one or more credit reporting networks and one or more credit reporting/credit risk systems, in different embodiments, any system or sub-system of the present disclosure can be in communication with one or more credit reporting/credit risk systems.

In certain embodiments, the system utilizes one mobile device application to interact with the different components of the gaming establishment fund management system to, amongst other actions, access funds maintained in the different gaming establishment accounts associated with the user. For example, utilizing the same mobile application, a mobile device interacts with both the first cashless wagering system of the gaming establishment fund management system and the gaming establishment retail wallet system of the gaming establishment fund management system. In certain embodiments, the system utilizes multiple mobile device applications to interact with the different components of the gaming establishment fund management system to, amongst other actions, access funds maintained in the different gaming establishment accounts associated with the user. In certain of these embodiments, the mobile device applications include a location based digital wallet enabled application, such as a Passbook-enabled or Wallet-enabled application, which is accessible when the user enters a gaming establishment. In certain of such embodiments, the mobile device applications are downloaded to the mobile device from an application store. In certain of such embodiments, the mobile device applications are downloaded to the mobile device from one or more websites affiliated with the gaming establishment (which are accessible directly by the user and/or by a link opened when the user scans a QR code).

It should be appreciated that in different embodiments, in addition to or alternatively from utilizing a mobile device running a mobile device application to, amongst other actions, access funds associated with different gaming establishment accounts, the system utilizes a kiosk, a gaming device (e.g., an interface of an EGM or gaming table component), a service window displayed by a gaming establishment device (e.g., a remote host controlled service window displayed by an EGM), a display device/input device associated with a seat-level gaming table component, a display device/input device associated with a table-level gaming table component, a display device/input device associated with a mobile gaming table component, a component of a gaming establishment patron management system, such as a player tracking unit, a retail point-of-sale terminal, and/or a gaming establishment interface, such as a casino desk, to, amongst other actions, access the funds associated with such gaming establishment accounts. It should be further appreciated that while illustrated in FIG. 1 as using a mobile device running a mobile device application to access funds associated with different gaming establishment accounts (e.g., a cashless wagering account and a gaming establishment retail account) as mentioned above, a physical instrument, such as a smart card or a user issued magnetic striped card may additionally or alternatively be utilized to enable a user access to such gaming establishment account.

In certain embodiments, the system enables a transfer of funds between different accounts maintained by different components associated with different gaming activities and/or non-gaming activities. In these embodiments, the system employs one or more services for interfacing with the various components to facilitate balance inquiry, account state synchronization and transferring funds amongst the different accounts maintained by these various components. In certain embodiments, such a service collects data from various components and utilizes such collected data to provide a singular view of the balances (or a plurality of singular views of different groupings of balances). In certain embodiments, such a service additionally or alternatively provides facilities to enforce rules associated with the different accounts maintained by the various components. In different such embodiments, these rules include, but are not limited to, jurisdictional controls, self-imposed limits, state governmental controls and federal governmental controls, wherein the system provides the logic to determine how, and how much, to transfer from each account of the various interconnected components to satisfy a request for funds while staying within the confines of such rules. In certain embodiments, such a service additionally or alternatively tracks and coalesces transaction history across the accounts of the interconnected components of the system. In these embodiments, all transactions within the system have a “master” transaction record that ties all of the various fund transfers to a single initiating funds transfer regardless of how many accounts were withdrawn to the satisfy the original request.

In various embodiments, in association with employing a dedicated bank account associated with a gaming establishment account, to enable the user to transfer funds in such an account to a gaming device and/or utilize such funds to purchase goods and/or services using a debit card associated with that dedicated bank account, the system collects certain information associated with the user. In certain embodiments, the system obtains information previously collected on behalf of a user when the user created a gaming establishment account, such as a cashless wagering account, a gaming establishment retail account and/or a gaming establishment patron management system account (e.g., a player tracking account). In certain embodiments, the system collects information in association with a user interacting with one or more touchpoints, such as a mobile device application being executed by a mobile device, a kiosk, a point-of-sale terminal, an EGM, a casino cage, and/or a website accessed from a browser, to provide such information. In such embodiments, the collected information includes certain user identifying information, such as, but not limited to, a full legal name, mother's maiden name, an address, a mailing address, a country of residence, a country of citizenship, a birthday (including birth location), contact information (e.g., phone number, email), a government issued identification card, a government issued driver's license, a government issued passport, a government issued social security number, a portion of a government issued social security number (e.g., the last four digits), income information (e.g., credit card information, debit card information, bank account information), biometric data (e.g., finger print, signature, or photo), or other such information. In certain embodiments, following such information being collected and/or made available by the user, the system utilizes part or all of such identifying information to perform (or operate with a financial institution to perform) one or more Know Your Customer (“KYC”) checks to validate the information.

In certain embodiments, the system requires the user to acknowledge a set of rules associated with the dedicated bank account by providing a signature or other such indication that the user has read and agrees to the set of rules associated with the dedicated bank account. For example, the set of rules of the account includes, but is not limited to: limits of the dedicated bank account, authorized users of the dedicated bank account, and/or acceptable funding sources of the dedicated bank account.

In certain embodiments, the system determines one or more controls or restrictions, such as use limits, to associate with the dedicated bank account and/or the payment instrument employed to access funds from such an account, wherein subject to such controls or restrictions, the system denies one or more attempted transactions or invokes one or more security measures. In these embodiments, to balance the need to prevent unauthorized access to the funds associated with the dedicated bank account against the need to provide a frictionless experience for users, the system dynamically employs one or more controls or restrictions such that certain transactions trigger the need to potentially employ enhanced security measures and certain transactions do not trigger the need to potentially employ enhanced security measures.

It should be appreciated while certain jurisdictions supports various types of limits on funds associated with gaming establishment accounts (e.g., certain Nevada regulations require deposit limits on each instrument used to fund an account and other Nevada regulations require a cashless wagering account to enable a user to set a deposit limit over a desired period of time), such limits associated with gaming establishment accounts are different from limits associated with financial institution accounts, such as bank accounts. Accordingly, if the funding of a gaming establishment account of a user, such as a cashless wagering account, effectively occurs as funding of a dedicated bank account created on behalf of the user, then the system will implement certain required limits (i.e., usage controls and/or restrictions) because the gaming establishment account, such as the cashless wagering account, is not otherwise directly exposed to the entirety of the funding/deposit operations. As explained below, in different embodiments, these limits are applicable per account, per payment instrument, per unit of time and/or per transaction.

In certain embodiments, the usage controls are associated with an amount of funds deposited in a dedicated bank account over a given period of time (e.g., hourly, daily, weekly, monthly). For example, the system places a $10000 per day limit on deposits of funds to a dedicated bank account associated with a gaming establishment account. In these embodiments, such usage controls pertain to the frequency of depositing funds in a dedicated bank account and/or the amounts deposited. In certain embodiments, these usage controls are applicable for each of the funding sources available to deposit funds in a dedicated bank account. In certain other embodiments, these usage controls are applicable for certain of, but not each of, the funding sources available to deposit funds in a dedicated bank account. For example, these usage controls are applicable for funding from banking sources, but not applicable for funding from other sources (which may have separate usage controls and/or security measures in place).

In certain embodiments, the usage controls are associated with an amount of funds withdrawn from a dedicated bank account associated with a gaming establishment account over a given period of time (e.g., hourly, daily, weekly, monthly). For example, the system places a $10000 per day limit on withdrawals of funds from a dedicated bank account associated with a gaming establishment account. In these embodiments, such usage controls pertain to the frequency of withdrawing funds from a dedicated bank account and/or the amounts accessed. In certain embodiments, these usage controls are applicable for each of the destinations of funds from a dedicated bank account. In certain other embodiments, these usage controls are applicable for certain of, but not each of, the destinations of funds from a dedicated bank account. For example, these usage controls are applicable for transfers to non-banking sources, but not applicable for transfers to banking sources (which may have separate usage controls and/or security measures in place).

In certain embodiments, the usage controls are associated with a quantity and/or an amount of transactions involving funds maintained in a dedicated bank account associated with a gaming establishment account over a given period of time (e.g., hourly, daily, weekly, monthly). For example, the system places a $2000 per day limit on purchases made using funds in a dedicated bank account associated with a gaming establishment account. In these embodiments, such usage controls pertain to the frequency of accessing funds in a dedicated bank account and/or the amounts accessed.

In certain embodiments, the usage controls are additionally or alternatively associated with the amount of a transaction involving funds maintained in a dedicated bank account associated with a gaming establishment account. In these embodiments, certain retail purchases having a value above a threshold value that trigger the use of one or more usage controls while other retail purchases that have a value below the threshold value do not trigger such usage controls.

In certain embodiments, the usage controls are associated with an identity of whom may initiate a transaction involving funds maintained in a dedicated bank account associated with a gaming establishment account. For example, the system determines that a user enrolled in player tracking system who qualifies as a bronze status member may spend up to $500 on purchases made using funds in a dedicated bank account created on behalf of that user, while another user who qualifies as a platinum status member may spend up to $20,000 on purchases made using a funds in a dedicated bank account created on behalf of that user. In certain such embodiments, one or more activities of the identified user may factor into the employment (or lack thereof) or usage controls. For example, the system adjusts a limit amount based on one or more of, has the user gambled or started a gaming session recently (e.g., last day, last hour), has the user won at a gaming establishment (and if so, the amount of those winnings), and/or is the user checked into the hotel of the gaming establishment.

In certain embodiments, the usage controls are associated with an identity of the retailer associated with a transaction involving funds maintained in a dedicated bank account associated with a gaming establishment account. In these embodiments, the system imposes, using a Merchant Category Code (MCC) or a white list or blacklist of retailers, usage controls on a type of industry or retailer thus eliminating an entire class of retailers from participating in the commerce.

In certain embodiments, the usage controls are additionally or alternatively associated with the type of good and/or service associated with the transaction involving funds maintained in a dedicated bank account associated with a gaming establishment account. In these embodiments, certain types of retail purchases trigger the use of one or more usage controls while other types of retail purchases do not trigger such usage controls. For example, a first category of purchases, such as food and beverage purchases, can be made using funds from a dedicated bank account without triggering any usage controls while a second category of purchases, such as clothing retail outlets and entertainment related charges, triggers one or more usage controls that must be satisfied before the completion of such purchases with funds from a dedicated bank account.

In certain embodiments, the usage controls are additionally or alternatively associated with a location of the retail purchase attempted to be made involving funds maintained in a dedicated bank account associated with a gaming establishment account. In these embodiments, different locations where the funds from the dedicated bank account may be used are associated with different usage controls required to use such funds. For example, a transaction involving funds maintained in a dedicated bank account associated with a gaming establishment account attempted in association with a first location within a gaming establishment do not trigger the use of one or more usage controls while a transaction, involving funds maintained in a dedicated bank account associated with a gaming establishment account attempted in association with a second location external from the gaming establishment trigger one or more usage controls. In this example, different gaming establishment affiliated partner locations may trigger different usage controls than different non-gaming establishment affiliated partner locations.

In certain embodiments, the usage controls are additionally or alternatively associated with a channel of commerce in which the transaction involving funds maintained in a dedicated bank account associated with a gaming establishment account is attempted to be made. In these embodiments, different channels of commerce (in certain instances determined via the merchant identifier of the retail establishment) where the funds from the dedicated bank account may be accessed are associated with different usage controls required to use such funds. In certain embodiments, the usage controls are additionally or alternatively associated with a time of when the transaction is attempted to be made. In certain embodiments, the usage controls are additionally or alternatively associated with an amount of funds currently maintained in a dedicated bank account associated with a user. In certain embodiments, the usage controls are additionally or alternatively associated with a current rate of consumption of the funds in one or more dedicated bank accounts maintained for the user. In one such embodiment, the rate of consumption is based on an amount of transactions made using funds from a dedicated bank account over a set period of time, such as the current day. In another such embodiment, the rate of consumption is based on an amount of transactions made using funds from a dedicated bank account over a rolling period of time, such as the past 24 hours.

In certain embodiments, in addition to or alternative from associating one or more usage controls with the dedicated bank account and/or a payment instrument employed to access funds from such an account, the system applies one or more restrictions responsive to a determination that a restriction placement event (i.e., a form of an account state change event) occurred or is suspected to have occurred. In certain embodiments, the restrictions applied to one or more accounts include blocking certain (or all) transactions attempted to be completed in association with such accounts. In certain embodiments, the restrictions applied to one or more accounts additionally or alternatively include locking certain of such accounts. In certain embodiments, the restrictions applied to one or more accounts additionally or alternatively include closing certain of such accounts. In different embodiments, such restrictions placed on one or more accounts include, but are not limited to: (i) a fraud restriction (e.g., an account is blocked due to concern that fraud may have occurred), (ii) a lost restriction (e.g., a user's debit card or player tracking card was lost), (iii) an abandoned restriction (e.g., a user's debit card or player tracking card was abandoned, such as a player tracking card being left in an EGM), (iv) a PIN lock restriction (e.g., too many failed attempts have occurred to validate a PIN associated with a user's debit card or player tracking card), (v) a signature restriction (e.g., a detection that key elements of the user's account may have been altered such that the signature on certain data has failed), (vi) a suspect restriction (e.g., an indication that a gaming establishment patron management system has placed a block on a player tracking card due to possible suspicious activity), and (vii) a maximum balance restriction (e.g., a user's account has the maximum allowed balance).

It should be appreciated that in different embodiments, the system employs a combination of these usage controls and/or restrictions to determine whether or not a transaction involving funds maintained in a dedicated bank account associated with a gaming establishment account is permitted and/or any security measures need to be activated. For example, usage controls and/or restrictions are based on whether a total amount of retail purchases made at a designated location on certain type of goods and/or services using funds from a dedicated bank account are over a designated period of time. In this example, if the total amount of retail purchases made at the designated location on the identified type of goods and/or services using funds from the dedicated bank account over the designated period of time meet or exceed a threshold, then the system denies the authorization of subsequent transactions and/or employs one or more enhanced security features.

In certain embodiments, the system enables an operator, such as a gaming establishment operator, to determine and activate zero, one or more usage controls, restrictions and/or security measures to associate with the dedicated bank account and/or the payment instrument employed to access funds from such an account. In these embodiments, if any operator determined usage controls, restrictions and/or security measures are violated, the system attempts to prevent unauthorized access to the funds associated with the dedicated bank account. In certain embodiments, the determination to associate one or more usage controls, restrictions and/or security measures is based on one or more inputs from an operator wherein personnel, such as gaming establishment personnel indicate that they would like one or more usage controls, restrictions and/or security measures associated with certain of (or each of) the transactions using funds from the dedicated bank account.

In certain embodiments, the system enables the user to determine and activate zero, one or more usage controls, restrictions and/or security measures to associate with the dedicated bank account and/or the payment instrument employed to access funds from such an account. In these embodiments, if any user determined usage controls, restrictions and/or security measures are violated, the system attempts to prevent unauthorized access to the funds associated with the dedicated bank account. In certain embodiments, the determination to associate one or more usage controls, restrictions and/or security measures is based on one or more inputs from the user wherein the user indicates that they would like one or more usage controls, restrictions and/or security measures associated with certain of (or each of) the purchases made using funds from the dedicated bank account. For example, the user sets a dedicated bank account usage limit for a set period of time, such as a calendar day, a set quantity of hours (e.g., 24 hours), and/or a period of time that aligns with a user's work pay period.

In certain embodiments, the determination to place any usage controls, restrictions and/or security measures is based on one or more actions (or inactions) of a user. In certain embodiments, the determination to place any usage controls, restrictions and/or security measures is additionally or alternatively based on an identity of the user. In one such embodiment, different restrictions are placed in association with different users having different status with the gaming establishment. In another such embodiment, different restrictions are placed in association with different users having different responsible gaming limits. In certain embodiments, the system additionally or alternatively determines to place any usage controls, restrictions and/or security measures based on a user's wagering activity. In another such embodiment, the system additionally or alternatively determines to place any usage controls, restrictions and/or security measures based on a user's gaming establishment retail purchasing activity. In certain embodiments, the system additionally or alternatively determines to place any usage controls, restrictions and/or security measures based on a user's collective experience at the gaming establishment. In another such embodiment, the system additionally or alternatively determines to place any usage controls, restrictions and/or security measures based on a user's retail purchasing activity occurring independent of the gaming establishment. In another such embodiment, the system determines to place any usage controls, restrictions and/or security measures based on determined historical preferences of the user.

In certain embodiments, the system enables a retail point-of-sale system to determine and activate one or more usage controls, restrictions and/or security measures to associate with transactions undertaken by the retail point-of-sale system which are associated with the dedicated bank account and/or the payment instrument employed to access funds from such an account. In certain of these embodiments, the determination to associate one or more usage controls, restrictions and/or security measures is based on one or more inputs from retail personnel whom indicate that they would like one or more usage controls, restrictions and/or security measures associated with certain of (or each of) the purchases made in association with the retail point-of-sale system. In certain other of these embodiments, the determination to associate one or more usage controls, restrictions and/or security measures is based on one or more settings associated with the retail point-of-sale system that dictate one or more usage controls, restrictions and/or security measures associated with certain of (or each of) the purchases made in association with the retail point-of-sale system. In certain embodiments, one or more determinations are made at the retail point-of-sale terminal level wherein different terminals are associated with different usage controls, restrictions and/or security measures. In certain embodiments, one or more determinations are made at the retail point-of-sale system level wherein each terminal is associated with the same usage controls, restrictions and/or security measures.

In certain embodiments, the enterprise electronic wallet system implements one or more usage controls, restrictions and/or security measures associated with the dedicated bank account and/or the payment instrument employed to access funds from such an account. In these embodiments, the enterprise electronic wallet system is tasked with monitoring activity of the dedicated bank account, such as funding transactions, and accepting or rejecting such activity based on the currently configured limits associated with the dedicated bank account relative to certain prior activity, if any, during an applicable period of time. For example, the enterprise electronic wallet system determines whether a funding transaction of a dedicated bank account created on behalf of a user complies with one or more limits and accept or reject the funding transaction based on such a determination. In this example, based on the compliance (or lack thereof) of one or more deposit limits imposed on the dedicated bank account created by the enterprise electronic wallet system, the enterprise electronic wallet system notifies the user of a status of the attempted deposit of funds into the dedicated bank account via a message displayed at any suitable device, via an email, via an SMS or text message, and/or via a notification displayed by a mobile device application.

In certain embodiments, the gaming establishment fund management system implements one or more usage controls, restrictions and/or security measures associated with the dedicated bank account and/or the payment instrument employed to access funds from such an account. In these embodiments, the gaming establishment fund management system is tasked with monitoring activity of the dedicated bank account, such as funding transactions, and accepting or rejecting such activity based on the currently configured limits associated with the dedicated bank account relative to certain prior activity, if any, during an applicable period of time. For example, the gaming establishment fund management system determines whether a funding transaction of a dedicated bank account created on behalf of a user complies with one or more limits and accepts or rejects the funding transaction based on such a determination. In this example, based on the compliance (or lack thereof) of one or more deposit limits imposed on the dedicated bank account created by the enterprise electronic wallet system, the gaming establishment fund management system notifies the user of a status of the attempted deposit of funds into the dedicated bank account via a message displayed at any suitable device, via an email, via an SMS or text message, and/or via a notification displayed by a mobile device application. In certain instances, since the gaming establishment fund management system has visibility into other types of deposit transactions, such as cash deposited into various gaming establishment verticals (e.g., cash deposited into an EGM or a kiosk), if the deposit limit needs to take account for these other types of deposit transactions, the gaming establishment fund management system is relatively better situated to impose certain limits.

It should be appreciated that in certain embodiments, since the ability to make retail purchases with funds deposited into a dedicated bank account associated with a gaming establishment account creates potential money laundering risks (e.g., a user could solely fund their account using illicit cash at an EGM, then transfer those funds back to their account and later use such funds to buy luxury goods or services from a retailer and/or a user could transfer illicit funds electronically into their account and then use such funds to make a purchase at a luxury retailer), the system of the present disclosure detects these scenarios, and potentially blocks them and/or reports them by providing the appropriate information that must be filed with financial crimes regulators in a given jurisdiction. In one such embodiment, the gaming establishment fund management system and/or enterprise electronic wallet system prevents a user from making a purchase using funds in a dedicated bank account if the funds transferred or deposited into the account have not been transferred to an EGM and/or a gambling touchpoint on a gaming establishment floor. In another such embodiment, the gaming establishment fund management system and/or enterprise electronic wallet system tracks funds that were deposited into an EGM (via cash or an instrument unaffiliated with a user, such as a ticket voucher) but were not wagered. In this embodiment, upon receipt of this information (that is, some transfer of funds into the dedicated bank account), the system restricts or prevents the user to make a purchase using such funds until those funds have been wagered with. In certain additional or alternative embodiments, one or more components of the gaming establishment fund management system and/or enterprise electronic wallet system reports on user attempts to make purchases using funds that have not been wagered. In one such embodiment, the system generates reports of all attempted retail purchases using funds in a dedicated bank account that have not been wagered over a defined lookback period. Such an embodiment enables gaming establishment personnel the ability to have the appropriate information to file one or more suspicious activity reports with financial crimes regulatory agencies, such as the US Treasury's FinCEN. In another such embodiment, upon detection of a suspicious financial transaction event, the system automatically fills in the appropriate regulatory agency report (e.g., Suspicious Activity Report (SAR), Currency Transaction Report (CTR)) for submission by the gaming establishment to the regulatory body. In another such embodiment, the system electronically submits the generated reports to the appropriate regulatory body.

In certain embodiments, the system employs the same usage controls, restrictions and/or security measures for each user whom attempts to transact against a respective dedicated bank account. In certain embodiments, the system employs different usage controls, restrictions and/or security measures for different users whom attempt to transact against a respective dedicated bank account. In certain of these embodiments, the system utilizes historical data regarding the user and past transactions in determining one or more aspects of one or more usage controls, restrictions and/or security measures to associate with that user. In certain of these embodiments, the system utilizes one or more attributes of the user, such as a player tracking account status of the user, in determining one or more aspects of one or more usage controls, restrictions and/or security measures to associate with that user.

In certain embodiments, if one or more components of one or more systems determine to associate one or more of the usage controls, restrictions and/or security measures with one or more accounts and/or a payment instrument employed to access funds from one or more of such accounts, a component of such systems, such as a component of an event system, stores information in association with such usage controls and/or restrictions. In one such embodiment, the component of such systems, such as a component of the event system, maintains a restriction database that stores data associated with the different restrictive states of different accounts and/or payment instruments employed to access funds from one or more of such accounts.

It should be appreciated that in certain embodiments, one or more of the usage controls and/or restrictions may be changed, such as overridden and/or adjusted by qualifying personnel, such as gaming establishment personnel. In these embodiments, the system associates different levels of modifications, such as different levels of overriding and/or adjusting of usage controls and/or restrictions with different qualifying personnel. In these embodiments, the system enables different levels of modifications, such as different levels of overriding and/or adjusting of usage controls and/or restrictions for different users based on one or more attributes, such as status or historical spend, of such users.

In certain embodiments, as the different components of the system are configured to send and/or receive data indicative of usage controls and/or restrictions associated with one or more accounts and/or payment instruments employed to access funds from one or more of such accounts, certain of such data includes an update time for when sent from a sending component, when received by a receiving component such that the receiving component will compare the timestamp with its own recorded last synchronized time. In certain additional or alternative embodiments, as certain data associated with one or more users changes from time to time, such as changes to any user identifying information, changes to one or more usage controls associated with one or more accounts and/or changes to one or more restrictions associated with one or more accounts, certain of such data includes an update time for when sent from a sending component, when received by a receiving component such that the receiving component will compare the timestamp with its own recorded last synchronized time. In these embodiments, if the sending component's update time on the data is later than the receiving component's stored last synchronized time, the receiving component will update its own data to ensure that both system components have the most up-to-date data associated with any user identifying information, any usage controls and/or any restrictions associated with one or more accounts and/or payment instruments employed to access funds from one or more of such accounts. In different embodiments, the transmission of data associated with any user identifying information, any usage controls and/or any restrictions associated with one or more accounts and/or payment instruments employed to access funds from one or more of such accounts may be stand-alone messages between the components of the system or may be included with or otherwise piggy-backed in other messages between components of the system, such as but not limited to balance inquiry messages and funds transfer messages.

In certain embodiments, when a change of data associated with an account state occurs (e.g., a change of user identifying information, a change of a usage control and/or a change of a restriction), the system enables certain pre-processing of the state change to enrich the data. As part of the data update process on one entity, the process could include, as configurable based upon what data was changed, a KYC process (or any other validation process) performed independently by each (or a specific) entity affected by the change. In certain embodiments, the entity where the change is made could perform the KYC process and assert in messaging that the data passed the applicable KYC process (or other validation process performed). Such a configuration enriches the data provided that describes the event and enables the recipient of the event to not have to perform additional verifications (or perform less verifications then would otherwise be required when processing the event).

In certain embodiments, one or more components of the system operate individually or collectively to determine if any usage controls and/or restrictions have been placed on any accounts and/or associated payment instruments and potentially propagate such usage controls and/or restrictions to other components of other systems (or sub-systems). In certain embodiments, one or more components of the system operate individually or collectively to determine if any modifications to any account information (e.g., user identifying information), any placed usage controls and/or any placed restrictions have occurred and potentially propagate such modifications to other components of other systems (or sub-systems). In certain such embodiments, the determination of whether or not to notify other systems is based on the nature of the usage control, the restriction and/or the modification and the extent to which that usage control, restriction and/or modification may potentially impact other systems. For example, if a server of a cashless wagering system determines that a restriction has been placed on a cashless wagering account because the cashless wagering account has reached a maximum allowed balance, since alerting other systems of this restriction is deemed unnecessary for the proper processing of the other systems (i.e., data associated with a cashless wagering account being placed in a maximum balance state does not need to be forwarded to a banking institution that maintains a dedicated bank account because such a maximum balance state should not prohibit the withdrawing of funds from the bank account), the server of the cashless wagering system determines not to share information regarding this restriction. In another example, if a server of a cashless wagering system determines that a restriction has been placed on a cashless wagering account because too many failed attempts have occurred to validate a PIN associated with the cashless wagering account, since alerting other systems of this security risk and corresponding restriction is deemed necessary, the server of the cashless wagering system determines to share information regarding this restriction.

In certain embodiments, this sharing of information by one system includes a component of that system generating an account state change event and a subscribing system, such as the event system, then performing some action upon the receipt of a account state account state change event. For example, if a component of a cashless wagering system places and/or detects a restriction on an account maintained by the cashless wagering system, the component of the cashless wagering system publishes an event to a component of the event system. In this example, a component of the banking institution that maintains the dedicated bank account receives, from the event system, data associated with this account state change event pertaining to the restriction placed on the cashless wagering account. The component of the banking institution that maintains the dedicated bank account then records that the dedicated bank account is also placed in a restrictive state, thereby preventing any transactions from being processed against that dedicated bank account. It should be appreciated that while this example describes the component of the banking institution that maintains the dedicated bank account placing one or more restrictions based on the event occurring in association with the cashless wagering account, other components of other systems, such as a component of an eWallet system or a component of a gaming establishment retail account system, are each configured to additionally or alternatively place one or more restrictions based on the events reported to the event system (and/or events monitored by the event system).

In certain embodiments, the bank account and the associated gaming establishment account are data peers such that neither the banking institution that maintains the bank account nor the gaming establishment fund management system that maintains the associated gaming establishment account owns the data. In these embodiments, based on the entity relationship between the banking institution that maintains the bank account and the gaming establishment fund management system that maintains the associated gaming establishment account, the data associated with one or more account state changes events can be modified using either entity as the change agent in which the entity that caused the change of the data to trigger the synchronization process.

In certain embodiments, one of the bank account or the associated gaming establishment account is considered the owner of a particular data field. In these embodiments, based on the entity relationship between the banking institution that maintains the bank account and the gaming establishment fund management system that maintains the associated gaming establishment account, the data associated with one or more account state changes events may be modified in association with the entity that owns the data and that entity triggers the synchronization process of such data to other systems (and/or sub-systems). In one such embodiment, the owner of a particular data field (e.g., the banking institution that maintains the bank account or the gaming establishment fund management system) requires a user to interface with that component to update the corresponding data associated with one or more account state change events, which results in a triggering of the synchronization process.

In certain embodiments, neither the banking institution that maintains the bank account nor the gaming establishment fund management system that maintains the associated gaming establishment account owns the data, but rather a third party owns such data. For example, a gaming establishment patron management system, such as a player tracking system or a casino management system, owns the data representative of the name and address of a user. In these embodiments, based on the entity relationship between the third party, the banking institution that maintains the bank account and the gaming establishment fund management system that maintains the associated gaming establishment account, the data associated with one or more account state changes events may be modified in association with the third party that owns the data and the third party triggers the synchronization process of such data to other systems (and/or sub-systems). In one such embodiment, the third party owner of a particular data field requires a user to interface with that component to update the corresponding data, which results in a triggering of the synchronization process.

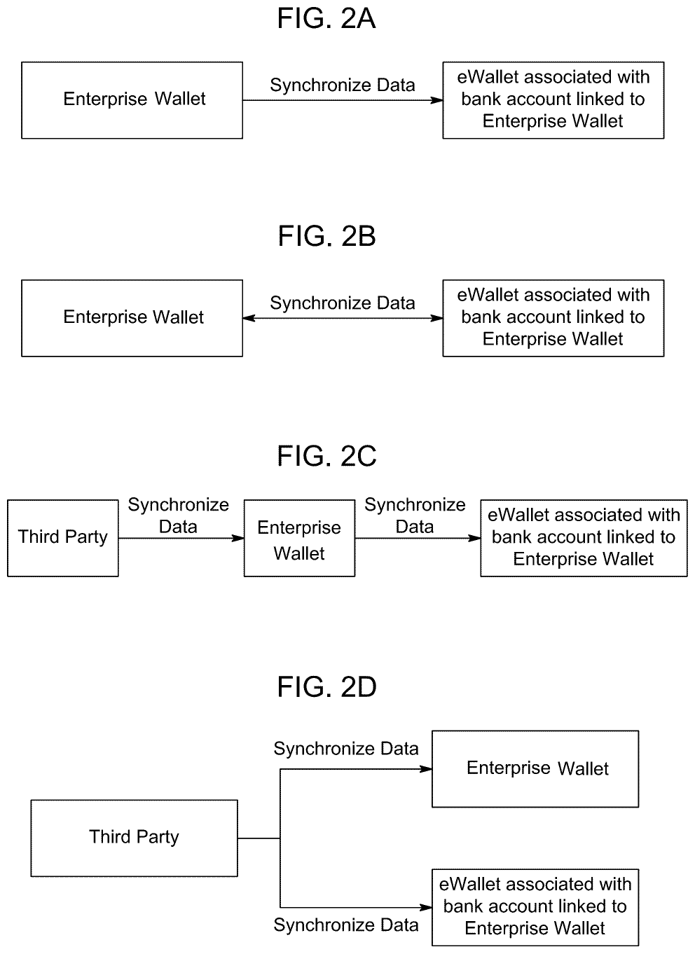

In different embodiments, the synchronization process takes different forms based on the owner, if any, of the data being initially provided and/or modified and various relationships between the different components interacting with each other. For example, as seen in FIG. 2A, when data is changeable in association with one entity, such as a gaming establishment fund management system that maintains a gaming establishment account (e.g., the enterprise wallet of FIG. 2A), a synchronization process occurs in which point-to-point communication is initiated by that one entity to communicate any applicable change to another entity (e.g., an eWallet system associated with a dedicated bank account linked to the enterprise wallet of FIG. 2A). In another example, as seen in FIG. 2B, when data is changeable in association with either entity (e.g., a gaming establishment fund management system that maintains a gaming establishment account or an eWallet system associated with a dedicated bank account), a synchronization process occurs in which bidirectional point-to-point communication is initiated by either entity to communicate any applicable change to the other entity. In another example, as seen in FIG. 2C, when data is changeable in association with a third party, a synchronization process occurs in which an indirect point-to-point communication is initiated by that third party to communicate any applicable change to one entity (e.g., a gaming establishment fund management system that maintains a gaming establishment account) and that entity communicates that change to another entity (e.g., an eWallet system associated with a dedicated bank account). In another example, as seen in FIG. 2D, when data is changeable in association with a third party, a synchronization process occurs in which a point-to-point communication is initiated by that third party to directly communicate any applicable change to multiple entities (e.g., a gaming establishment fund management system that maintains a gaming establishment account and an eWallet system associated with a dedicated bank account). It should be appreciated that while these examples illustrate multiple point-to-point communication schemes, a bus oriented and/or event oriented publish and subscribe scheme could additionally or alternatively be employed for communicating synchronization data between the entities. In such instances, the entity updating the data would publish an event describing any applicable change and the other entities, having previously subscribed for synchronization events, would learn of (and act on if warranted) the change when the event was published.

Accordingly, in various embodiments, responsive to an occurrence of an account state change event initiated (and/or completed) by a first component of a first system, the system of the present disclosure enables that first component of the first system to directly (or indirectly, such as via a component of an event system) notify other components of other systems which may then modify one or more attributes of one or more accounts maintained by such other systems. In certain such embodiments in which the account state change event includes an occurrence of a material event that warrants heightened security (i.e., a usage control placement event and/or a restriction placement event), the system of the present disclosure enables a usage control and/or a restriction to be placed by a first component of a first system and that first component of the first system to directly (or indirectly, such as via a component of an event system) notify other components of other systems which may then modify one or more restrictions placed on the accounts and/or payment instruments maintained by such other systems. For example, following the component of the banking institution that maintains the bank account associated with the gaming establishment account receiving data of an occurrence of an account state change event of a block being placed on the gaming establishment account, that component records that the dedicated bank account (and therefore any associated payment instrument, such as a debit card) is also in a block state which prevents any transactions, such as debit card transactions, from being processed. In certain instances of this example, while the component of the banking institution that maintains the dedicated bank account prevents purchase or withdrawal transactions to proceed, such a component supports successfully processing refund transactions while the dedicated bank account (or any associated payment instrument) is in a block state.

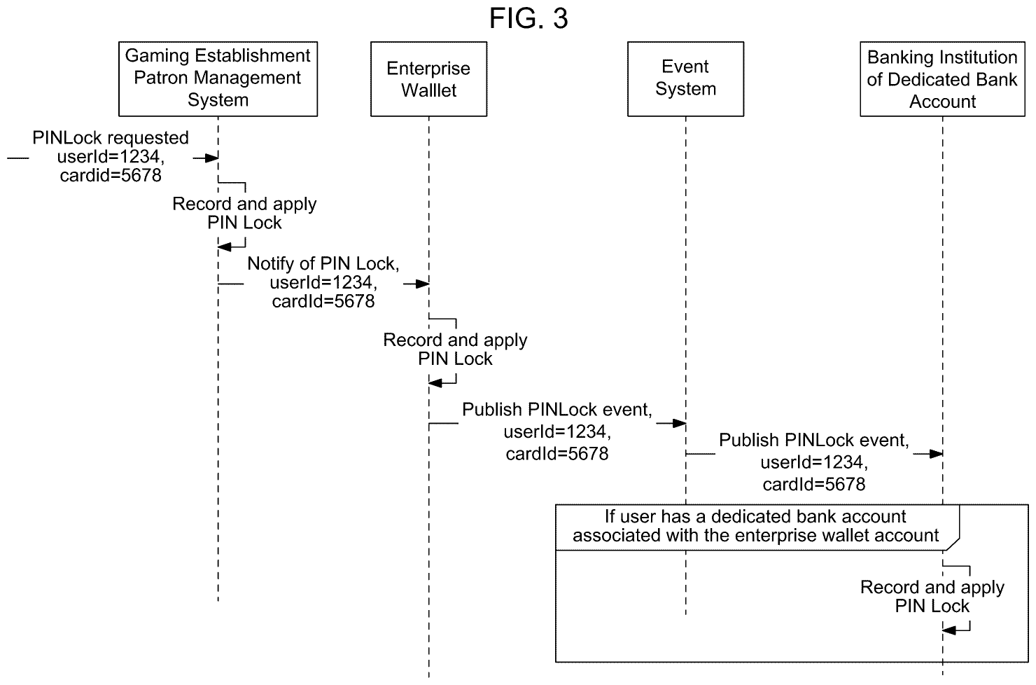

In another such example, as seen in FIG. 3 (which illustrates the described interactions between a gaming establishment patron management system, a gaming establishment fund management system, the event system and the banking institution that maintains the dedicated bank account), if it is detected that too many invalid PIN attempts have been made in association with a player tracking account, such as too many invalid PIN entries received by a slot machine interface board (“SMIB”) of an EGM or received by the EGM, a player tracking system (i.e., the gaming establishment patron management system) that maintains the player tracking account places a block (i.e., a restriction) on the player tracking account for security reasons and updates the state of the player tracking account to record the block. The player tracking system then notifies the cashless wagering system (i.e., the component of the gaming establishment fund management system) to modify the user's cashless wagering account (i.e., the enterprise wallet) to be placed in a restrictive state. In this example, the cashless wagering system will update the account status to record the block, thereby preventing any cashless transfers while the block is active. The cashless wagering system will also publish to the event system an account restriction event (e.g., the PIN Lock event) so that other subscribers, such as the banking institution that maintains the dedicated bank account, can learn about the account restriction event. In this example, upon receipt of data associated with the account restriction event, the banking institution that maintains the dedicated bank account will determine if the user referenced in the account restriction event has a debit card issued, and if so, the banking institution that maintains the dedicated bank account will update the restrictive state of the debit card to prevent new purchase transactions (while, in certain instances, still permitting refund transactions).

In certain embodiments, in addition to or alternative from the usage control and/or restriction originating from a component of a gaming establishment system, one or more usage controls and/or restrictions may originate from a component of the banking institution that maintains the dedicated bank account. In such embodiments in which the account state change event includes an occurrence of a material event that warrants heightened security (i.e., a usage control placement event and/or a restriction placement event), the component of the banking institution that maintains the dedicated bank account applies one or more restrictions and then directly (or indirectly, such as via a component of an event system) notifies one or more components of one or more gaming establishment systems which may then modify one or more restrictions placed on the gaming establishment accounts maintained by such gaming establishment systems. In one such example, if a lock (i.e., a restriction) occurs in association with a debit card because too many invalid or incorrect PIN attempts to access funds in a user's cashless wagering account using the debit card, the banking institution that maintains the dedicated bank account places a restriction on the debit card and publishes an account restriction event (e.g., the PIN Lock event) to the event system so that other subscribers can learn about the account restriction event and place one or more account restrictions as deemed appropriate. In another embodiment, the banking institution that maintains the dedicated bank account (or any component of any system with data associated with one or more placed restrictions to share) notifies one or more other components of other systems directly, such as via a direct application programming interface (“API”) call (e.g., such as a REST API call). In this embodiment, upon receiving the directed API call, the other components of other systems may place one or more account restrictions as deemed appropriate.

In certain embodiments, in addition to one or more components of one or more systems placing one or more account usage controls and/or restrictions to, among other benefits, reduce the likelihood of one or more frauds occurring in association with such accounts, such components of such systems enable these account restrictions to be lifted or otherwise removed. For example, responsive to a user's successful request (e.g., a user interfaces with gaming establishment personnel to successfully clear or resolve an account restriction or a user makes one or more inputs to a gaming establishment interface to successfully clear or resolve an account restriction) or upon a determination that the restriction is no longer applicable, one or more components of one or more systems lift or otherwise remove the restriction in place and propagate data associated with such a restrictive state change to other components of other systems to also update one or more restrictive states of one or more accounts and/or debit cards. In certain of these embodiments, one or more of the restrictions may be overridden and/or adjusted by qualifying gaming establishment personnel, qualifying retail personnel and/or qualifying debit card issuer personnel. In certain such embodiments, the gaming establishment fund management system, the banking institution that maintains the dedicated bank account, the retail point-of-sale system and/or the event system associates different levels of overriding and/or adjusting restrictions with different qualifying gaming establishment personnel, qualifying retail personnel and/or qualifying debit card issuer personnel.

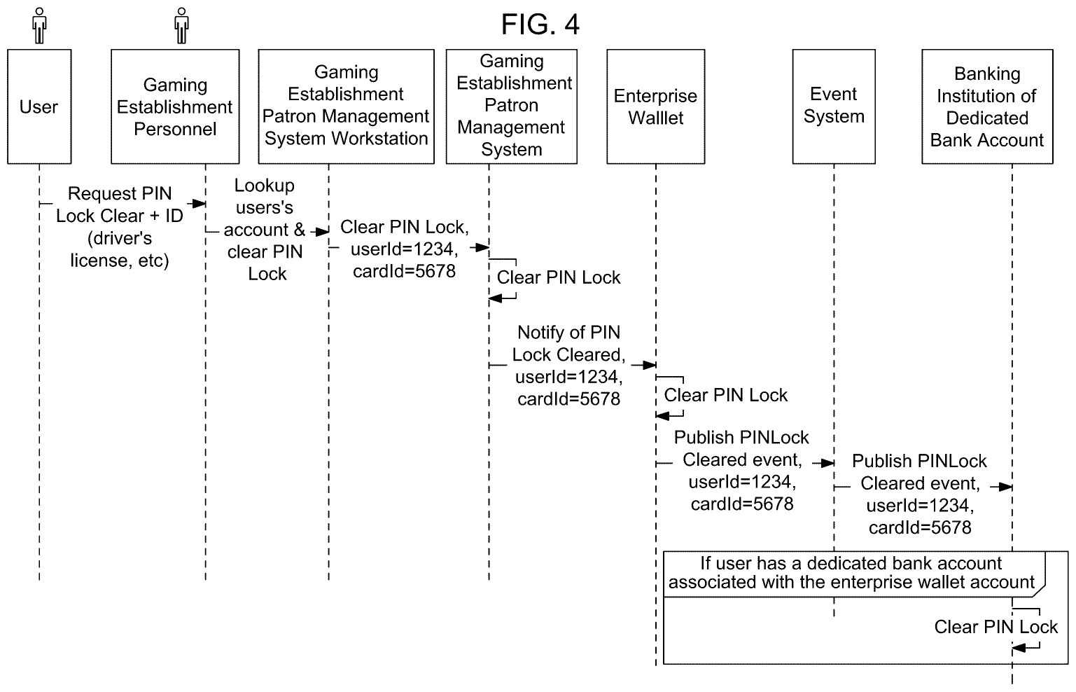

Accordingly, in various embodiments in which the account state change event includes an occurrence of an event that warrants deescalated security, the system of the present disclosure enables a restriction to be removed by a first component of a first system and that first component of the first system to directly (or indirectly, such as via a component of an event system) notify other components of other systems which may then modify, such as also remove, one or more restrictions placed on the accounts and/or payment instruments maintained by such other systems. In one such example, as seen in FIG. 4 (which illustrates the described interactions between a user, gaming establishment personnel operating at a gaming establishment workstation, a gaming establishment patron management system, a gaming establishment fund management system, an event system and a banking institution that maintains the dedicated bank account), if a user successfully interfaces with gaming establishment personnel to cause a block (i.e., a restriction) associated with a player tracking account to be lifted or cleared, the player tracking system (i.e., the gaming establishment patron management system) that maintains the player tracking account is instructed of this cleared restriction. The gaming establishment patron management system will update the state of the player tracking account to record the removal of the block, and then notify the gaming cashless wagering system to modify the user's cashless wagering account (i.e., the enterprise wallet) to also clear a restriction placed on the user's cashless wagering account. In this example, the cashless wagering system will also update the account status to record the cleared block, thereby enabling cashless transfers to occur again. The cashless wagering system will also publish to the event system a cleared account restriction event (e.g., the PIN Lock Cleared event) so that other subscribers, such as the banking institution that maintains the dedicated bank account, can learn about the cleared account restriction event. In this example, upon receipt of data associated with the cleared account restriction event, the banking institution that maintains the dedicated bank account will determine if the user referenced in the cleared account restriction event has a debit card issued, and if so, the banking institution that maintains the dedicated bank account will update the restrictive state of the debit card to enable new purchase transactions using the debit card linked to the user's cashless wagering account.

In certain embodiments, in addition to potentially placing one or more usage controls and/or restrictions on one or more gaming establishment accounts and/or associated bank accounts, the system enables a user to attempt to make certain retail transactions using the payment instrument associated with the bank account. In certain embodiments, to employ a payment instrument associated with the dedicated bank account to facilitate the use of funds from that account to an account associated with a retailer to purchase goods and/or services from the retailer, the user presents the payment instrument, such as a debit card, to potentially access the funds in the dedicated bank account for the purchase transaction. In certain such embodiments wherein the payment instrument is presented in virtual or electronic form using a mobile device application, such as an electronic wallet that stores debit card data, the mobile device application prompts the user to cause the mobile device to engage the point-of-sale terminal, such as prompting the user to tap the mobile device to a designated portion of the point-of-sale terminal (or otherwise moving the mobile device to within a designated distance of a designated location of the point-of-sale terminal). Such engagement initiates a pairing or linkage between the mobile device and the point-of-sale terminal, wherein the pairing or linkage between the mobile device and the point-of-sale terminal occurs via one or more applications being run or executed on the mobile device. In this example, after such engagement, the mobile device application communicates, via a wireless communication protocol (including, but not limited to: Bluetooth™, Bluetooth™ Low Energy (“BLE”), one or more cellular communication standards (e.g., 3G, 4G, 5G, 6G, LTE), one or more Wi-Fi compatible standards, and one or more short range communication protocols (e.g., a near field communication (“NFC”) protocol), data associated with the debit card to the point-of-sale terminal to facilitate the potential purchase of goods and/or services.

It should be appreciated that in certain embodiments, the user needs to take one or more steps to approve a transaction to access funds in a dedicated bank account using a payment instrument, such as a debit card. In one such embodiment, the user acknowledges the approval of accessing funds in the bank account associated with the gaming establishment account using the payment instrument, when needed, by entering PIN via a mobile device application, providing a signature and/or presenting a biometric identifier to a mobile device. In another embodiment, the user acknowledges the approval of accessing funds in the bank account associated with the gaming establishment account using a payment instrument, when needed, by entering a PIN, providing a signature and/or presenting a biometric identifier to the retail point-of-sale terminal or a peripheral device associated with the retail point-of-sale terminal.

In various embodiments, upon the presentation of the payment instrument at an applicable point-of-sale terminal of a retail point-of-sale system, the components of the systems individually or collectively determine whether or not any usage controls and/or restrictions are in place and also whether or not to complete the attempted retail purchase using funds maintained in the bank account associated with the gaming establishment account.

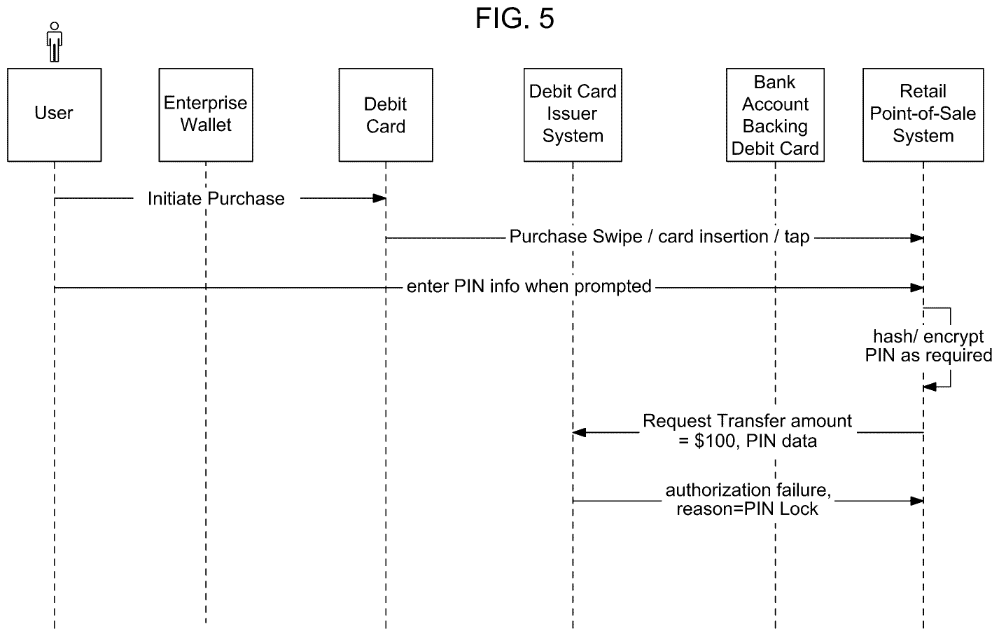

In certain such embodiments, if the system determines that one or more restrictions are in place, the system denies or prevents the attempted transaction from occurring with minimal involvement of the gaming establishment fund management system. For example, as seen in FIG. 5 (which illustrates the described interactions between the user, the gaming establishment fund management system, the banking institution that maintains the dedicated bank account and issued a debit card associated with that bank account, and the retail point-of-sale system), following the presentation of the debit card to a retail point-of-sale system, if the banking institution that maintains the dedicated bank account (i.e., the debit card issuer system) determines that a restriction is in place on one or more gaming establishment accounts and/or the debit card employed to access funds from one or more of such gaming establishment accounts, the banking institution that maintains the dedicated bank account interfaces with the retail point-of-sale system to deny the attempted purchase transaction and communicate information to the retail point-of-sale system regarding this automatic denial (due to the placed restriction). In certain other embodiments, upon receiving data or information regarding the debit card, the retail point-of-sale system communicates with the banking institution that maintains the dedicated bank account to request a transfer of an amount of funds to cover the cost of the intended purchase. The banking institution that maintains the dedicated bank account in turn operates with the gaming establishment fund management system and the event system to determine the applicability of any restrictions placed on the gaming establishment account which the funds for the purchase will be drawn from and/or placed on the debit card.

As evidenced by the various embodiments described, in addition to the system of the present disclosure providing a user instant access outside of a gaming establishment to funds that would otherwise reside in a gaming establishment account for gaming purposes by creating and integrating a bank account with a gaming establishment account maintained for that user, the system enables the automatic propagation of data associated with such accounts to the various entities that maintain such accounts. Such sharing of data provides that an updated security measure and/or change in one or more attributes associated with one account is communicated from a source component of a source system to different components of different systems such that the security measure and/or change is accessible from each of these different components (independent of whether these different components are subsequently in communication with the source component) to reduce occurrences of fraud being propagated against multiple interconnected account.

It should be appreciated that any functionality or process of the present disclosure may be implemented via one or more servers (associated with or independent of any component of any system of the present disclosure), one or more non-gaming establishment devices (e.g., a point-of-sale terminal of a retailer located external to and independent of a gaming establishment), a mobile device application, one or more gaming establishment devices (e.g., a gaming device such as an EGM or a non-gaming device such as a point-of-sale terminal of a retailer located within or otherwise associated with a gaming establishment), and/or one or more components of a gaming establishment system (such as a component of a gaming establishment management system supported by or otherwise located inside a gaming establishment device and/or a non-gaming establishment device). Accordingly: (i) while certain functions, features or processes are described herein as being performed by a non-gaming establishment device, such functions, features or processes may alternatively be performed by one or more servers, or one or more mobile device applications, one or more gaming establishment devices, and/or one or more gaming establishment components, and (ii) while certain functions, features or processes are described herein as being performed by one or more servers (e.g., a server of an enterprise electronic wallet system, a server of a gaming establishment fund management system and/or a server of a retail point-of-sale system), such functions, features or processes may alternatively be performed by one or more gaming establishment devices, one or more components of a gaming establishment system, one or more non-gaming establishment devices, one or more mobile device applications, or one or more gaming establishment components.

In certain embodiments, the above-described embodiments of the present disclosure may be implemented in accordance with or in conjunction with zero, one or more components of a gaming establishment fund management system (e.g., a cashless wagering system or a gaming establishment retail system); zero, one or more components of an enterprise electronic wallet system; zero, one or more components of a gaming establishment patron management system; zero, one or more components of a retail point-of-sale system; and/or zero, one or more gaming establishment devices. In these embodiments, such components of the gaming establishment fund management system, the enterprise electronic wallet system, the gaming establishment patron management system, the retail point-of-sale system and/or the gaming establishment device each include a controller including at least one processor.

The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the gaming establishment fund management system, the component of the enterprise electronic wallet system, the component of the retail point-of-sale system and/or the gaming establishment device; (3) accessing memory to configure or reconfigure parameters in the memory according to indicia read from the component of the gaming establishment fund management system, the component of the enterprise electronic wallet system, the component of the retail point-of-sale system and/or the gaming establishment device; (4) communicating with interfaces and the peripheral devices (such as input/output devices); and/or (5) controlling the peripheral devices. In certain embodiments, one or more components of the controller (such as the at least one processor) reside within a housing of the component of the gaming establishment fund management system, the component of the enterprise electronic wallet system, the component of the retail point-of-sale system and/or the gaming establishment device, while in other embodiments, at least one component of the controller resides outside of the housing of the component of the gaming establishment fund management system, the component of the enterprise electronic wallet system, the component of the retail point-of-sale system and/or the gaming establishment device.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the gaming establishment fund management system, the component of the enterprise electronic wallet system, the component of the retail point-of-sale system and/or the gaming establishment device disclosed herein. In certain embodiments, the at least one memory device resides within the housing of the component of the gaming establishment fund management system, the component of the enterprise electronic wallet system, the component of the retail point-of-sale system and/or the gaming establishment device, while in other embodiments at least one component of the at least one memory device resides outside of the housing of the component of the gaming establishment fund management system, the component of the enterprise electronic wallet system, the component of the retail point-of-sale system and/or the gaming establishment device. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the gaming establishment fund management system, the component of the enterprise electronic wallet system, the component of the retail point-of-sale system and/or the gaming establishment device; (2) associations between configuration indicia read from the component of the gaming establishment fund management system, the component of the enterprise electronic wallet system, the component of the retail point-of-sale system and/or the gaming establishment device with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the gaming establishment fund management system, the component of the enterprise electronic wallet system, the component of the retail point-of-sale system and/or the gaming establishment device to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the gaming establishment fund management system, the component of the enterprise electronic wallet system, the component of the retail point-of-sale system and/or the gaming establishment device to control the component of the gaming establishment fund management system, the component of the enterprise electronic wallet system, the component of the retail point-of-sale system and/or the gaming establishment device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a retail patron uses such a removable memory device in a component of the gaming establishment fund management system to implement at least part of the present disclosure. In other embodiments, part or all of the program code and/or the operating data is downloaded to the at least one memory device of the component of the gaming establishment fund management system, the component of the enterprise electronic wallet system, the component of the retail point-of-sale system and/or the gaming establishment device through any suitable data network described above (such as an Internet or intranet).

The at least one memory device also stores a plurality of device drivers. Examples of different types of device drivers include device drivers for the component of the gaming establishment fund management system, the component of the enterprise electronic wallet system, the component of the retail point-of-sale system and/or the gaming establishment device and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the gaming establishment fund management system, the component of the enterprise electronic wallet system, the component of the retail point-of-sale system and/or the gaming establishment device. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the component of the gaming establishment fund management system, the component of the enterprise electronic wallet system, the component of the retail point-of-sale system and/or the gaming establishment device loads the new device driver from the at least one memory device to enable communication with the new device. For instance, one type of card reader in the component of the gaming establishment fund management system, the component of the enterprise electronic wallet system, the component of the retail point-of-sale system and/or the gaming establishment device can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the component of the gaming establishment fund management system, the component of the enterprise electronic wallet system, the component of the retail point-of-sale system and/or the gaming establishment device and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the component of the gaming establishment fund management system, the component of the enterprise electronic wallet system, the component of the retail point-of-sale system and/or the gaming establishment device. In various embodiments, the display devices serve as digital glass configured to aspects of the gaming establishment in which the component of the gaming establishment fund management system, the component of the enterprise electronic wallet system, the component of the retail point-of-sale system and/or the gaming establishment device is located. In various embodiments, the component of the gaming establishment fund management system, the component of the enterprise electronic wallet system, the component of the retail point-of-sale system and/or the gaming establishment device includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. In these embodiments, after the component of the gaming establishment fund management system, the component of the enterprise electronic wallet system, the component of the retail point-of-sale system and/or the gaming establishment device receives an actuation, the component of the gaming establishment fund management system, the component of the enterprise electronic wallet system, the component of the retail point-of-sale system and/or the gaming establishment device causes the payout device to provide a payment to the user. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the user following receipt of an actuation of the cashout device, the payout device is configured to cause a payment to be provided to the user in the form of an electronic funds transfer, such as via a direct deposit into a bank account, a casino account, or a prepaid account of the user; via a transfer of funds onto an electronically recordable identification card or smart card of the user; or via sending a virtual ticket having a monetary value to an electronic device of the user.

In certain embodiments, the at least one output device is a sound generating device controlled by one or more sound cards. In one such embodiment, the sound generating device includes one or more speakers or other sound generating hardware and/or software configured to generate sounds, such as by playing music. In another such embodiment, the component of the gaming establishment fund management system, the component of the enterprise electronic wallet system, the component of the retail point-of-sale system and/or the gaming establishment device provides dynamic sounds coupled with attractive multimedia images displayed on one or more of the display devices to provide an audio-visual representation or to otherwise display full-motion video with sound to attract users to the component of the gaming establishment fund management system, the component of the enterprise electronic wallet system, the component of the retail point-of-sale system and/or the gaming establishment device. In certain embodiments, the component of the gaming establishment fund management system, the component of the enterprise electronic wallet system, the component of the retail point-of-sale system and/or the gaming establishment device displays a sequence of audio and/or visual attraction messages during idle periods to attract potential users to the component of the gaming establishment fund management system, the component of the enterprise electronic wallet system, the component of the retail point-of-sale system and/or the gaming establishment device. The videos may be customized to provide any appropriate information.

The at least one input device may include any suitable device that enables an input signal to be produced and received by the at least one processor of the component of the gaming establishment fund management system, the component of the enterprise electronic wallet system, the component of the retail point-of-sale system and/or the gaming establishment device. In one embodiment, the at least one input device includes a payment device configured to communicate with the at least one processor of the component of the gaming establishment fund management system, the component of the enterprise electronic wallet system, the component of the retail point-of-sale system and/or the gaming establishment device to fund the component of the gaming establishment fund management system, the component of the enterprise electronic wallet system, the component of the retail point-of-sale system and/or the gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In one embodiment, the at least one input device includes a payment device configured to enable the component of the gaming establishment fund management system, the component of the enterprise electronic wallet system, the component of the retail point-of-sale system and/or the gaming establishment device to be funded via an electronic funds transfer, such as a transfer of funds from a bank account. In another embodiment, the component of the gaming establishment fund management system, the component of the enterprise electronic wallet system, the component of the retail point-of-sale system and/or the gaming establishment device includes a payment device configured to communicate with a mobile device of a user, such as a mobile phone, a radio frequency identification tag, or any other suitable wired or wireless device, to retrieve relevant information associated with that user to fund the component of the gaming establishment fund management system, the component of the enterprise electronic wallet system, the component of the retail point-of-sale system and/or the gaming establishment device. When the component of the gaming establishment fund management system, the component of the enterprise electronic wallet system, the component of the retail point-of-sale system and/or the gaming establishment device is funded, the at least one processor determines the amount of funds entered and displays the corresponding amount.

In various embodiments, the at least one input device includes a plurality of buttons that are programmable by the component of the gaming establishment fund management system, the component of the enterprise electronic wallet system, the component of the retail point-of-sale system and/or the gaming establishment device operator to, when actuated, cause the component of the gaming establishment fund management system, the component of the enterprise electronic wallet system, the component of the retail point-of-sale system and/or the gaming establishment device to perform particular functions. For instance, such buttons may be hard keys, programmable soft keys, or icons icon displayed on a display device of the component of the gaming establishment fund management system, the component of the enterprise electronic wallet system, the component of the retail point-of-sale system and/or the gaming establishment device that are actuatable via a touch screen of the component of the gaming establishment fund management system, the component of the enterprise electronic wallet system, the component of the retail point-of-sale system and/or the gaming establishment device or via use of a suitable input device of the component of the gaming establishment fund management system, the component of the enterprise electronic wallet system, the component of the retail point-of-sale system and/or the gaming establishment device. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the component of the gaming establishment fund management system, the component of the enterprise electronic wallet system, the component of the retail point-of-sale system and/or the gaming establishment device by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the component of the gaming establishment fund management system, the component of the enterprise electronic wallet system, the component of the retail point-of-sale system and/or the gaming establishment device. In one embodiment, a user input device docking region is provided, and includes a power distribution component that is configured to recharge a user input device without requiring metal-to-metal contact. In one embodiment, the at least one power distribution component is configured to distribute power to one or more internal components of the component of the gaming establishment fund management system, the component of the enterprise electronic wallet system, the component of the retail point-of-sale system and/or the gaming establishment device, such as one or more rechargeable power sources (e.g., rechargeable batteries) located at the component of the gaming establishment fund management system, the component of the enterprise electronic wallet system, the component of the retail point-of-sale system and/or the gaming establishment device.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the component of the gaming establishment fund management system, the component of the enterprise electronic wallet system, the component of the retail point-of-sale system and/or the gaming establishment device; detecting the presence and/or identity of various persons (e.g., users, casino employees, etc.), devices (e.g., user input devices), and/or systems within a predetermined proximity to the component of the gaming establishment fund management system, the component of the enterprise electronic wallet system, the component of the retail point-of-sale system and/or the gaming establishment device.

The at least one data preservation component is configured to detect or sense one or more events and/or conditions that, for example, may result in damage to the component of the gaming establishment fund management system, the component of the enterprise electronic wallet system, the component of the retail point-of-sale system and/or the gaming establishment device and/or that may result in loss of information associated with the component of the gaming establishment fund management system, the component of the enterprise electronic wallet system, the component of the retail point-of-sale system and/or the gaming establishment device. Additionally, the data preservation system may be operable to initiate one or more appropriate action(s) in response to the detection of such events/conditions.

The at least one motion/gesture analysis and interpretation component is configured to analyze and/or interpret information relating to detected user movements and/or gestures to determine appropriate user input information relating to the detected user movements and/or gestures. For example, in one embodiment, the at least one motion/gesture analysis and interpretation component is configured to perform one or more of the following functions: analyze the detected gross motion or gestures of a user; interpret the user's motion or gestures (e.g., in the context of a casino game being played) to identify instructions or input from the user; utilize the interpreted instructions/input to advance the game state; etc. In other embodiments, at least a portion of these additional functions may be implemented at a remote system or device.

The at least one portable power source enables the component of the gaming establishment fund management system, the component of the enterprise electronic wallet system, the component of the retail point-of-sale system and/or the gaming establishment device to operate in a mobile environment.

The at least one geolocation module is configured to acquire geolocation information from one or more remote sources and use the acquired geolocation information to determine information relating to a relative and/or absolute position of the component of the gaming establishment fund management system, the component of the enterprise electronic wallet system, the component of the retail point-of-sale system and/or the gaming establishment device. For example, in one implementation, the at least one geolocation module is configured to receive GPS signal information for use in determining the position or location of the component of the gaming establishment fund management system, the component of the enterprise electronic wallet system, the component of the retail point-of-sale system and/or the gaming establishment device. In another implementation, the at least one geolocation module is configured to receive multiple wireless signals from multiple remote devices (e.g., component of the gaming establishment fund management system, the gaming establishment patron management system, the retail point-of-sale system and/or the gaming establishment devices, servers, wireless access points, etc.) and use the signal information to compute position/location information relating to the position or location of the component of the gaming establishment fund management system, the component of the enterprise electronic wallet system, the component of the retail point-of-sale system and/or the gaming establishment device.

The at least one user identification module is configured to determine the identity of the current user or current owner of the component of the gaming establishment fund management system, the component of the enterprise electronic wallet system, the component of the retail point-of-sale system and/or the gaming establishment device. For example, in one embodiment, the current user is required to perform a login process at the component of the gaming establishment fund management system, the component of the enterprise electronic wallet system, the component of the retail point-of-sale system and/or the gaming establishment device in order to access one or more features. Alternatively, the component of the gaming establishment fund management system, the component of the enterprise electronic wallet system, the component of the retail point-of-sale system and/or the gaming establishment device is configured to automatically determine the identity of the current user based on one or more external signals, such as an RFID tag or badge worn by the current user and that provides a wireless signal to the component of the gaming establishment fund management system, the component of the enterprise electronic wallet system, the component of the retail point-of-sale system and/or the gaming establishment device that is used to determine the identity of the current user. In at least one embodiment, various security features are incorporated into the component of the gaming establishment fund management system, the component of the enterprise electronic wallet system, the component of the retail point-of-sale system and/or the gaming establishment device to prevent unauthorized users from accessing confidential or sensitive information.

The at least one information filtering module is configured to perform filtering (e.g., based on specified criteria) of selected information to be displayed at one or more displays of the component of the gaming establishment fund management system, the component of the enterprise electronic wallet system, the component of the retail point-of-sale system and/or the gaming establishment device.

In various embodiments, the component of the gaming establishment fund management system, the component of the enterprise electronic wallet system, the component of the retail point-of-sale system and/or the gaming establishment device includes a plurality of communication ports configured to enable the at least one processor of the component of the gaming establishment fund management system, the component of the enterprise electronic wallet system, the component of the retail point-of-sale system and/or the gaming establishment device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, the component of the gaming establishment fund management system, the component of the enterprise electronic wallet system, the component of the retail point-of-sale system and/or the gaming establishment device has a support structure, housing, or cabinet that provides support for a plurality of the input devices and the output devices of the component of the gaming establishment fund management system, the component of the enterprise electronic wallet system, the component of the retail point-of-sale system and/or the gaming establishment device.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor responsive to a restriction placement event occurring in association with a gaming establishment account, cause the processor to:
place a restriction on the gaming establishment account, and
communicate data associated with the placed restriction, wherein responsive to a component of a banking institution that maintains a dedicated bank account created on behalf of a user and linked to the gaming establishment account receiving the data, the component of the banking institution determines whether to place the restriction on the dedicated bank account.

2. The system of claim 1, wherein the gaming establishment account comprises a player tracking account.

3. The system of claim 1, wherein the gaming establishment account comprises a cashless wagering account.

4. The system of claim 3, wherein responsive to the determination being not to place the restriction on the dedicated bank account, a debit card associated with the dedicated bank account is operable to access funds maintained in the cashless wagering account in association with a purchase transaction initiated in association with the debit card at a point-of-sale terminal.

5. The system of claim 1, wherein the data associated with the placed restriction is communicated to a component of an event system which communicates the data associated with the placed restriction to the component of the banking institution.

6. The system of claim 1, wherein a first restriction placement event is associated with the placement of the restriction on the dedicated bank account and a second, different restriction placement event is associated with no placement of the restriction on the dedicated bank account.

7. The system of claim 1, wherein the restriction comprises any of a block, a lock and a closure.

8. The system of claim 1, wherein responsive to the determination being to place the restriction on the dedicated bank account, a payment instrument associated with the dedicated bank account is operable to facilitate a refund transaction initiated in association with the payment instrument at a point-of-sale terminal.

9. The system of claim 1, wherein the restriction placement event comprises a predetermined quantity of incorrect personal identification numbers being inputted in association with the gaming establishment account.

10. A system comprising:
a processor; and
a memory device that stores a plurality of instructions that, when executed by the processor responsive to a placed restriction associated with a gaming establishment account being cleared, cause the processor to communicate data associated with the cleared restriction to a component of an event system which publishes the data associated with the cleared restriction, wherein responsive to a component of a banking institution that maintains a dedicated bank account created on behalf of a user and linked to the gaming establishment account receiving the data associated with the cleared restriction, the component of the banking institution determines whether to clear a corresponding restriction placed on the dedicated bank account.

11. The system of claim 10, wherein the placed restriction comprises any of a block, a lock and a closure.

12. A method of operating a system, the method comprising:
responsive to a restriction placement event occurring in association with a gaming establishment account:
placing, by a processor, a restriction on the gaming establishment account, and communicating data associated with the placed restriction, wherein responsive to a component of a banking institution that maintains a dedicated bank account created on behalf of a user and linked to the gaming establishment account receiving the data, the component of the banking institution determines whether to place the restriction on the dedicated bank account.

13. The method of claim 12, wherein the gaming establishment account comprises a player tracking account.

14. The method of claim 12, wherein the gaming establishment account comprises a cashless wagering account.

15. The method of claim 14, wherein responsive to the determination being not to place the restriction on the dedicated bank account, a debit card associated with the dedicated bank account is operable to access funds maintained in the cashless wagering account in association with a purchase transaction initiated in association with the debit card at a point-of-sale terminal.

16. The method of claim 12, wherein the data associated with the placed restriction is communicated to a component of an event system which communicates the data associated with the placed restriction to the component of the banking institution.

17. The method of claim 12, wherein a first restriction placement event is associated with the placement of the restriction on the dedicated bank account and a second, different restriction placement event is associated with no placement of the restriction on the dedicated bank account.

18. The method of claim 12, wherein the restriction comprises any of a block, a lock and a closure.

19. The method of claim 12, wherein responsive to the determination being to place the restriction on the dedicated bank account, a payment instrument associated with the dedicated bank account is operable to facilitate a refund transaction initiated in association with the payment instrument at a point-of-sale terminal.

20. The method of claim 12, wherein the restriction placement event comprises a predetermined quantity of incorrect personal identification numbers being inputted in association with the gaming establishment account.
